(19) United States
(12) Patent Application Publication
(10) Pub. No.: US 2025/0197111 A1
(43) Pub. Date: Jun. 19, 2025

(54) END-TO-END AUTOMATED FULFILLMENT CENTER SYSTEMS AND METHODS

(71) Applicant: Nimble Robotics, Inc., San Francisco, CA (US)

(72) Inventors: Simon Kalouche, San Francisco, CA (US); Jordan Dawson, San Francisco, CA (US); Matthew Shekels, Daly City, CA (US); Dexter Dickinson, Lafayette, CO (US)

(73) Assignee: Nimble Robotics, Inc., San Francisco, CA (US)

(21) Appl. No.: 19/065,595

(22) Filed: Feb. 27, 2025

Related U.S. Application Data
(63) Continuation-in-part of application No. PCT/US2023/031408, filed on Aug. 29, 2023.
(60) Provisional application No. 63/401,873, filed on Aug. 29, 2022.

(51) Int. Cl. B65G 1/04; B65B 5/10; B65B 7/02; B65B 43/10; B65G 1/137; G06Q 10/087

(52) U.S. Cl. CPC B65G 1/0464; B65B 5/105; B65B 7/02; B65B 43/10; B65G 1/1375; G06Q 10/087

(57) ABSTRACT

A warehouse equipped with systems for automated order fulfilment includes a storage and retrieval system and a sealing machine. The storage and retrieval system includes a storage structure designed to house storage bins in stacks and one or more robots. The storage structure having pillars supporting a first set of rails and a second set of rails collectively forming a grid defining a plurality of grid spaces such that each of the stacks are housed within a footprint of a respective grid space. The one or more robots being operational on the grid and including a body coupled to a wheel assembly, the wheel assembly including a plurality of wheels and a drive mechanism arranged to move the body along the first and/or second sets of rails and a picking arm for placing the inventory items directly into a vessel for outbound shipment to an end user.

### CROSS-REFERENCE TO RELATED APPLICATIONS

This application is a continuation-in-part of International Patent Application No. PCT/US2023/031408, filed Aug. 29, 2023, which claims the benefit of the filing date of U.S. Provisional Application No. 63/401,873, filed Aug. 29, 2022, each of the disclosure of which is hereby incorporated herein by reference.

### TECHNICAL FIELD

The present disclosure relates to distribution fulfillment centers, and more particularly, to automated robotic order fulfillment systems within a distribution fulfillment center.

### BACKGROUND OF THE INVENTION

Distribution fulfillment centers, such as warehouses, require systems that unload incoming inventory, store the inventory within storage structures, pick-and-pack items into individual orders, and ship the orders to consumers. Each of these order fulfillment processes typically require the assistance of warehouse personnel and, as a result, can lead to inefficiencies, increased expenses, liability, and the likelihood of error.

Incoming inventory containers are ordinarily unloaded from a delivery truck, and outgoing packages are typically loaded into a delivery truck, by loading dock personnel, either manually or with the help of one or more machines or robotic systems. When inventory containers are manually unloaded from the delivery truck, the loading dock personnel remove containers from the trailer (e.g., the cargo area) in successively stacked rows extending along the width of the trailer beginning with the rows adjacent the rear of the trailer. This process is labor intensive. Furthermore, when a first row of containers is removed, a second row located behind the first row, is no longer supported and is subject to topping, which can result in damage to the inventory items, inefficiencies in unloading rate, or injury to the loading personal dock. It will be appreciated that the containers cannot be manually unloaded in levels (top down throughout the trailer), which would stabilize the containers during unloading, without requiring the loading dock personnel to climb on top of the containers that have not yet been unloaded. The same problems are also present while loading outbound packages.

Warehouse personnel often also assist in performing other order fulfillment processes and/or transporting inventory between various stations within a warehouse. For example, inventory items are traditionally stored within the warehouse on rows of shelving on either side of an aisle. The aisles are required to provide access between the shelving for an operator to migrate the aisles and retrieve the items. It is well understood, however, that the aisles reduce the storage density of the warehouse. In other words, the amount of space used for the storage of products (eg, the shelving) is relatively small compared to the amount of space required for the storage system as a whole.

In one alternative approach, which offers a significant improvement in storage density, storage containers are stacked on top of one another and arranged in adjacent rows. That is, no aisle is provided between the adjacent rows of stacked containers.

Various methods for retrieving inventory from the stacked containers have been contemplated. For example, US Pat. Pub. No. 2021/0032034, which is incorporated by reference herein in its entirety, discloses a system in which containers are stacked and arranged in a plurality of rows underneath a grid, and the containers are retrieved by robots which subsequently pick and pack inventory into order bins. While the robots revealed in US Pat. Pub. No. 2021/0032034 automates the process of picking and packing inventory, further automation of the warehouse is desired to reduce or eliminate the presence of personnel, thereby lowering costs and improving efficiency.

### BRIEF SUMMARY OF THE INVENTION

The automated order fulfillment systems disclosed herein reduce, if not eliminate, personnel required to operate the warehouse and improve space utilization of the warehouse. In one aspect of the present disclosures, an order fulfillment system includes: a storage and retrieval system including a grid-based storage structure and one or more robots operational on the grid; and a sealing machine for sealing a vessel and forming a package. The storage structure is arranged to house storage bins in stacks and includes vertical pillars supporting a first set of rails and a second set of rails extending perpendicular to the first set of rails. The first and second sets of rails collectively form a grid defining a plurality of grid spaces such that each of the stacks are housed within a footprint of a respective grid space. The one or more robots has a body coupled to a wheel assembly including a plurality of wheels and a drive mechanism arranged to move the body along the first and/or second sets of rails; and a picking arm for placing inventory items directly into the vessel for outbound shipment to an end user.

In some examples, the sealing machine may be an auto-bagger and the vessel may be a polybag.

The auto-bagger may be disposed on the grid, or alternatively, adjacent the grid and at a height that may be substantially equal to a height of the grid.

The order and fulfillment system may further include a plurality of chutes extending from the grid to a respective gay lord.

The vessel may alternatively be a cardboard and the order fulfillment system may further include a cardboard erector located upstream of the storage structure.

The sealing machine may be a carton sealing machine located downstream of the storage structure and arranged to seal the carton and form a package.

The one or more robots may further include a grapple suspended from support arms by cables connected to a winding mechanism to adjust a height of the grapple in a vertical direction, the grapple may be arranged to secure the storage bins and a tray upon which a cardboard may be seated.

The order fulfillment system may further include a loading/unloading device for unloading containers from a cargo area of a vehicle and/or loading packages into the cargo area of the vehicle.

The loading/unloading device may be an autonomous gantry which may include: a pair of beams extending in a first direction; a rail extending between the pair of beams and movable along the pair of beams in the first direction; and a hoist coupled to and movable along the rail in a second direction transverse to the first direction. The hoist may include a plate having a securely movable device in a vertical direction relative to the rail between a retracted position and an extended position.

In another aspect of the present disclosure, an order fulfillment system includes: a storage and retrieval system including a grid-based storage structure arranged to house storage bins in stacks, one or more robots operational on the grid, an auto-packing machine located downstream of the storage structure, and a manipulator robot. The storage structure defines a plurality of I/O modules and includes vertical pillars supporting a first set of rails and a second set of rails extending perpendicular to the first set of rails. The first and second sets of rails collectively forming a grid defining a plurality of grid spaces such that each of the stacks are housed within a footprint of a respective grid space. The one or more robots has a body coupled to a wheel assembly including a plurality of wheels and a drive mechanism arranged to move the body along the first and/or second sets of rails, and a grapple movable in a vertical direction and arranged to selectively secure and lift at least one of the storage bins from one of the stacks to a location above the grid. The manipulator robot includes a picking arm for picking one or more items from an order bin and placing the one or more picked items into the autopacking machine.

The auto-packing machine may be a cardboard wrap machine arranged to form a package of a custom size around the one or more items.

The manipulator robot may be disposed downstream of the storage structure and the manipulator robot may place the one or more picked items from the order bin into the cardboard wrap machine.

The manipulator robot may be placed on the grid and indirectly place the one or more picked items into the cardboard wrap machine via a chute and/or a conveyor.

The fulfillment system may further include a sorting system. In one example, the sorting system may be a sorting grid located adjacent to and at a lower height than a height of the grid. The sorting system may include: a frame having vertical pillars supporting a first set of rails and a second set of rails extending perpendicular to the first set of rails, the first and second sets of rails collectively forming the sorting grid and defining a plurality of sorting grid spaces.

The sorting system may further include sorting bins, each of the sorting bins may be transitionable between a closed position, in which items are retained within the sorting bin, and an open position in which items are dispensed from the sorting bin.

The sorting bin may further include a hammer and a trigger for transitioning the sorting bin from the closed position to the open position.

The sorting system may further include one or more sorting robots operable on the sorting grid. The sorting robots may further include: a body coupled to a wheel assembly including a plurality of wheels and a drive mechanism arranged to move the body along the first and second sets of rails of the sorting grid; and a grapple suspended from support arms by cables connected to a winding mechanism to adjust a height of the grapple in a vertical direction. The grapple may be arranged to secure and lift one of the sorting bins which may be transitioned from the closed position to the open position when the hammer of the sorting bin contacts the support arms of the sorting robot.

The sorting system may further include a plurality of gaylords arranged about a perimeter of the sorting grid.

The auto-packing machine may be an auto-bagger.

In yet another aspect, an order fulfillment method includes the following steps: moving one or more robots about a storage structure including a grid formed of a first set of parallel rails and a second set of parallel rails extending perpendicular to the first set of parallel rails; picking items from storage bins using a picking arm of the one or more robots; placing the picked items into one or more partitioned sections within one or more order bins secured to the one or more robots such that each partitioned section holds either one or more units of a single SKU or items pertaining to a single order; and transferring the picked items from the one or more order bins into either (1) an auto-packing machine disposed on or adjacent to the storage structure to form a package, or (2) an open carton configured to be shipped to an end consumer.

The transferring step may include transferring the picked items, using the one or more robots, from the one or more order bins directly into an auto-packing machine disposed on or adjacent the grid to form a package, and a subsequent transferring step of transferring the package to a gaylord or pallet disposed outside of the storage structure.

The subsequent transferring step may be at least partially performed by a chute.

The package may be placed on the chute by the picking arm of the robot.

The package may be deposited on the chute when the one or more robots transitions an openable bottom of a sorting bin from a closed position to an open position.

The openable bottom may be mechanically actuated by a grapple of the one or more robots.

The transferring step may originate on the grid and may be performed at least in part by the one or more robots and may include transferring the picked items into a vessel configured to be shipped to a consumer.

The vessel may be a cardboard disposed within the storage and retrieval system.

The method may further include a subsequent transferring step which may include lowering the carton within an I/O module, using a grapple of the one or more robots, and passing the carton through a carton sealing machine.

The vessel may be the open carton disposed outside the storage and retrieval system and the transferring step may be performed at least in part by a chute or a conveyor disposed between the storage structure and the carton.

The transferring step may originate on the grid and may be performed at least in part by the one or more robots and including transferring the picked items into a cardboard wrap machine.

The transferring step may be at least partially performed by a chute.

The transferring step may originate on or adjacent a sorting grid located adjacent to the grid and the transferring step may be performed at least in part by the one or more other robots.

The items, or the package containing the items, may not be scanned between a time in which the items are stored in the storage structure and a time in which when the package is staged for outbound shipment.

In yet another aspect of the present disclosure, a method of delivering packages includes, securing a package to an autonomous drone; and depositing the package within a receiving locker secured within a window of a building.

The receiving locker may include a bottom and at least three lateral sides.

The receiving locker may have an open or openable top.

### BRIEF DESCRIPTION OF THE DRAWINGS

FIG. 1 is a high-level schematic flow diagram illustrating automated order fulfillment systems within a warehouse according to an embodiment of the disclosure.

FIGS. 2-4 are schematic perspective views illustrating a process of unloading containers from a vehicle using a loading/unloading device.

FIG. 5 is a perspective view of the loading/unloading device of FIGS. 2-4.

FIG. 6 is a perspective view of a CubiScan machine according to an embodiment of the present disclosure.

FIGS. 7A-7C are perspective views of an example inventory removal station illustrating a robotic manipulator decanting a container, transferring contents of the container to a storage bin, and disposing of the container.

FIGS. 8A-8B are perspective views of another example inventory removal station illustrating a robotic manipulator provided with a cutting tool.

FIG. 9 is a schematic perspective view of a storage structure for housing a plurality of stacked containers.

FIG. 10 is a top elevation view of a portion of the storage structure of FIG. 9.

FIG. 11A is a perspective view of a mobile robot including a picking arm and a grapple arranged to operate on top of the storage structure of FIG. 9.

FIG. 11B is a perspective view of an order bin tray securable to the grapple of the robot of FIG. 11A.

FIG. 11C is a perspective view of an order bin in the form of a cardboard being transferred to the order bin tray of FIG. 11B.

FIGS. 12A-E are perspective views of a carton erector designed to erect cartons of a predetermined size according to an embodiment of the present disclosure.

FIG. 13 is a perspective view of a carton erector designed to erect cartons of a custom size according to an embodiment of the present disclosure.

FIGS. 14-16 are perspective views of a carton-wrap machine folding a packaging unit around an inventory item to form a package.

FIG. 17 is a perspective view of an auto-bagger.

FIG. 18 is a perspective view of a carton sealing machine.

FIGS. 19-20 are schematic perspective views of a process of loading packages into a vehicle using the loading/unloading device of FIG. 5.

FIG. 21 is a schematic of a portion of a warehouse depicting automated order fulfillment systems according to an embodiment of the present disclosure.

FIG. 22A is a schematic depicting a portion of a grid-based storage structure and a sorting grid according to an embodiment of the present disclosure.

FIG. 22B is a partial side elevation view of FIG. 22A.

FIG. 22C is a partial side elevation view of an auto-bagger machine arranged adjacent to the grid of the grid-based storage structure of FIG. 22A.

FIGS. 22D and 22E are partial perspective views of an auto-bagger machine arranged on the grid of the grid-based storage structure of FIG. 22A.

FIG. 22F is a partial perspective view of the warehouse of FIG. 1.

FIG. 22G is a partial perspective view of an auto-bagger machine arranged on a mobile robot and on the grid of the grid-based storage structure of FIG. 22A.

FIG. 23 is a perspective view of a sorting bin including hatch doors according to an embodiment of the present disclosure.

FIGS. 24A-24C are side elevation views of the grapple of the robot of FIG. 11A actuating the hatch doors of the sorting bin of FIG. 23.

FIG. 25 is a perspective view of a delivery robot in accordance with an embodiment of the present disclosure.

FIG. 26 is a perspective view of a package being deposited by a drone into a receiving locker in accordance with an embodiment of the present disclosure.

### DETAILED DESCRIPTION

The technology disclosed herein relates to a warehouse equipped with autonomous systems for order fulfillment and delivery. The autonomous systems are arranged to unload containers of inbound inventory from a vehicle, transport the containers to an inventory removal station, and transfer the inventory into storage bins. The storage bins may then be organized, slotted, and stored within an automated storage and retrieval system, for example, a grid-based storage structure. When an order is received, robots may traverse the grid-based storage structure to pick inventory and transfer the picked inventory to an order bin or an auto-packing machine, which may seal and label the package for shipping. The packaged inventory may then be transported to a loading/unloading device and loaded into a vehicle for outbound shipping.

As used herein, the terms “automated” or “autonomous” refer to a device or a system capable of operating autonomously at least some of the time. Put differently, the terms “automated” or “autonomous” include devices and systems that are operated with the assistance of a human at certain times so long as they can be operated autonomously at least some of the time. Is it also noted that the terms “container,” “storage bin,” “order bin,” and “package” refer to any vessel capable of housing one or more items. These terms are used merely for readability as the inventory is transferred between different vessels at various order fulfillment stages. For the avoidance of doubt, unless explicitly stated otherwise, the terms “container,” “storage bin,” “order bin,” and “package” encompasses any vessel including, bins, totes, cartons, bags, or any other structure capable of storing inventory items. Also as used herein, the terms “substantially,” “generally,” “about” and the like are intended to mean that slight deviations from absolute are included within the scope of the term so modified.

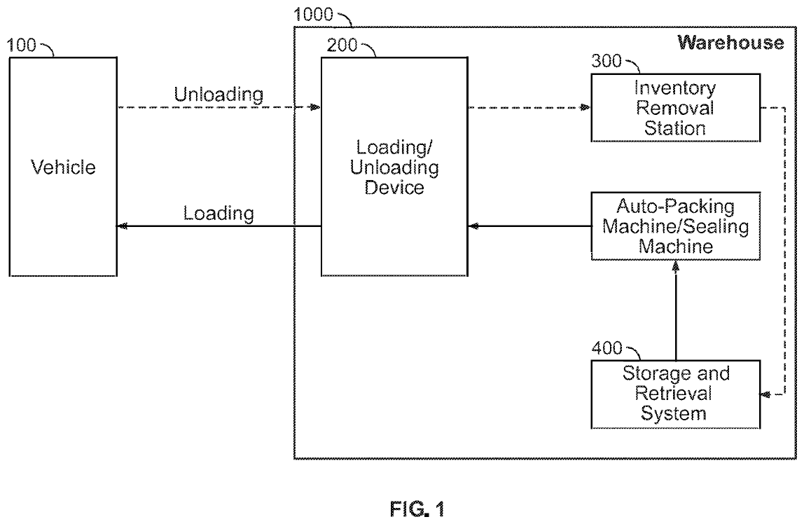

FIG. 1 is a high-level schematic flow diagram illustrating an fulfilment process performed by a series of fulfilment systems. The process begins by unloading containers of inbound inventory from a vehicle 100 and transporting those containers into a warehouse 1000 via a loading/unloading device 200. The containers may then be transported to an inventory removal station 300 where the inventory is transferred into storage bins. Thereafter, the storage bins may be transported to a storage structure within a storage and retrieval system 400 and stored until an order is received. Once the order is received, item(s) pertaining to the received order are retrieved from the storage structure, packed into an order bin, and transported to an auto-packaging machine and/or a sealing machine to form a package. The formed packages are then transported to loading/unloading device 200 and loaded into vehicle 100 for outbound shipping. Each fulfilment system schematically depicted in FIG. 1 is described in greater detail below.

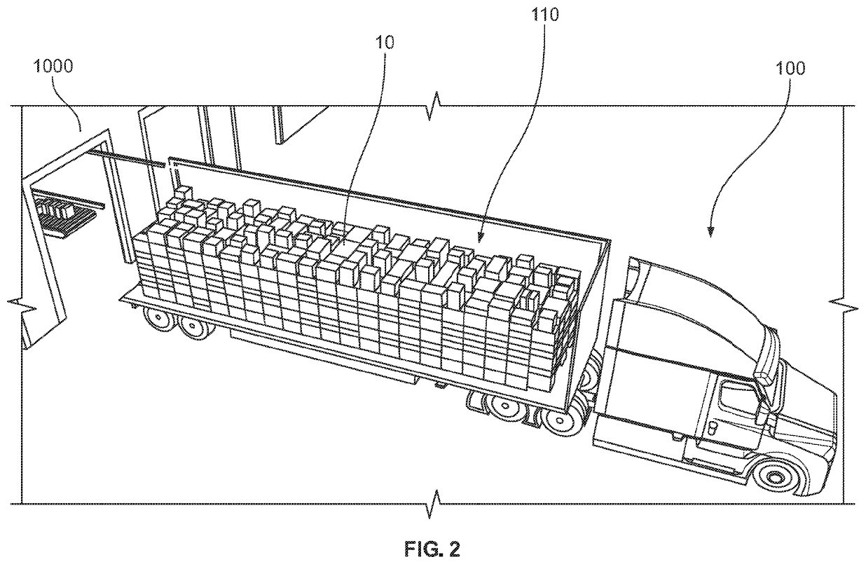

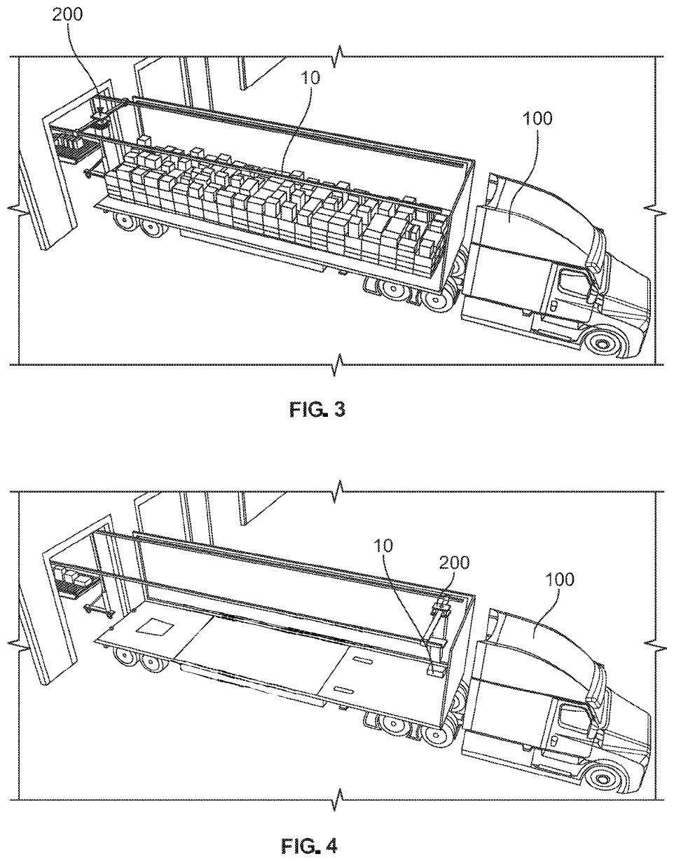

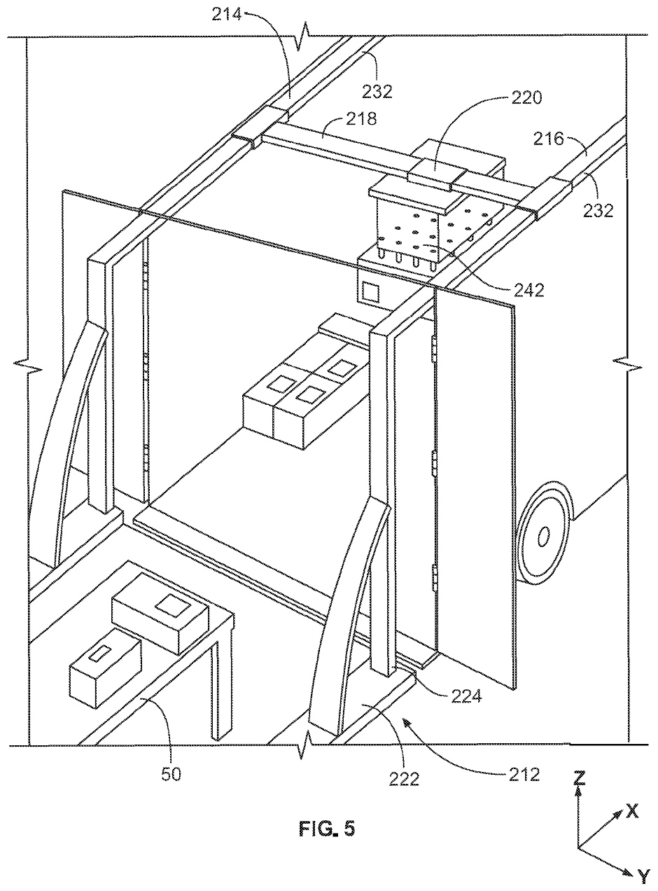

FIGS. 2-4 illustrate a process of delivering inventory via a vehicle 100 to warehouse 1000. Vehicle 100, carrying containers 10 of inbound inventory, may be maneuvered to position the cargo area 110 of the vehicle adjacent to a dock door of warehouse 1000. Loading/unloading device 200 may then be deployed to unload containers 10 from the cargo area 110 of vehicle 100. Containers 10 may be unloaded one container at a time or multiple containers at a time. After containers 10 have been unloaded, loading/unloading device 200 may place the containers on a conveyor to transport the containers to a destination within warehouse 1000 such as inventory removal station 300 (FIG. 1). Alternatively, loading/unloading device 200 may place containers 10 on another surface, such as the ground or a queuing buffer, before the containers are transported by an autonomous mobile robot (AMR) or another transportation mechanism to inventory removal station 300.

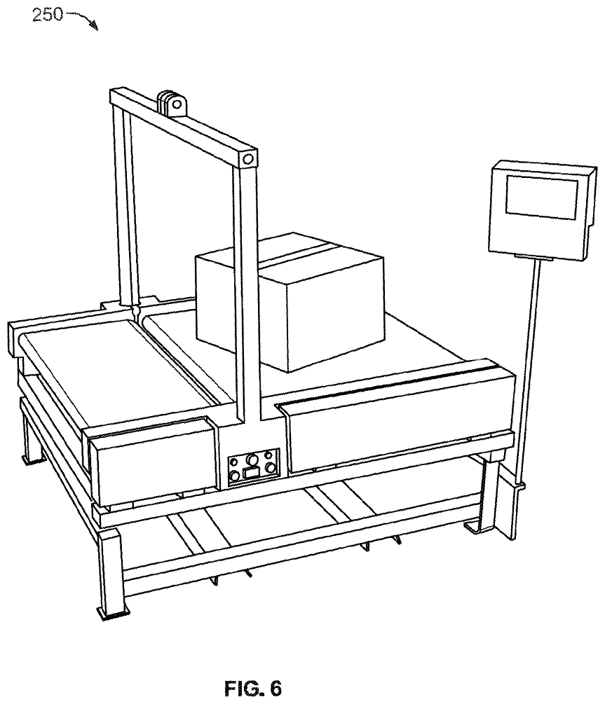

With additional reference to FIG. 5, loading/unloading device 200 includes a first beam 214 and a second beam 216, a rail 218 extending between first and second carriages mounted respectively to the first and second beams, and a hoist 220 suspended underneath a movable trolley along the rail. Hoist 220 includes an extendable and retractable plate 242 arranged to unload containers 10 from the cargo area 110 of vehicle 100 and/or load the containers into the cargo area of the delivery vehicle. While the term “cargo area” is primarily described herein as the trailer of a semi-trailer truck, the term is inclusive of the cargo area of other vehicles such as box trucks, u-hauls, step vans, buses, or any other vehicle capable of carrying cargo. Additionally, “cargo area” can refer to a staging area within the warehouse where containers are stacked on pallets or large crates before the staging medium and all of the containers staged thereon are loaded into a delivery vehicle. In some implementations, operation of loading/unloading device 200 is automated by one or more processors. That is, loading/unloading device 200 operates without a human manually operating its components. In other implementations, operation of loading/unloading device 200 may be controlled by loading dock personnel or remote personnel, via remote teleoperation using a graphical user interface (GUI), electronic signals, manually, or a combination of the foregoing.

In some examples, first beam 214 and second beam 216 are fixed to a structure within warehouse 1000 and arranged to extend and retract through the dock door to position hoist 220 within the trailer of vehicle 100. In other examples, loading/unloading device 200 may include a base 212 formed of feet 222 and legs 224. The feet 222 may include rollers, such as wheels, carriages, or bearings, to move loading/unloading device 200 across a ground surface and a locking mechanism to prevent the rollers from unintentionally rolling. When feet 222 include rollers, loading/unloading device 200 can be moved between docks, thereby allowing a single loading/unloading device to load and/or unload cargo from semi-trailers parked at different loading docks. As a result, capital investment costs may be reduced.

First beam 214 and second beam 216 include a track 232 upon which a respective carriage is mounted. Rail 218 is connected between the first and second carriages such that the rail is movable along tracks 232 in the x-direction (eg, along the length of the first and second beams). Rail 218 may include a position sensor such as an encoder and one or more actuators to drive movement of the rail. Example actuators include a linear actuator, a belt, chain, a lead or ball screw and the like. In this regard, a processor can determine the location of rail 218 relative to track 232 and generate and transmit processor executable control signals to automaton the movement of the rail along the length of the beams.

Hoist 220 is coupled underneath a trolley which is movably mounted to rail 218 such that the hoist is movable along the rail in the y-direction. Hoist 220 includes a plate 242 suspended by cables connected to a winding mechanism such as a spool, reel, or winch. The cables can thus be wound and unwound to move plate 242 relative to the trolley in the z-direction. Hoist 220 may include a position sensor and one or more actuators to automate the movement of the hoist along the rail in the y-direction and to automate the extension and retraction of plate 242 in the z-direction. The combination of the movement of rail 218 along the beams in the x-direction, the movement of hoist 220 along the rail in the y-direction, and the extension and retraction of plate 242 in the z-direction, allows the hoist to load/unload containers 10 from any area of the semi-trailer.

Plate 242 may optionally include one or more suction cups designed to secure containers 10 via a suction force. When plate 242 includes suction cups, a pneumatic source (not shown), such as a vacuum source or a compressor, is provided to generate the pneumatic force necessary to operate the suction cups. If the pneumatic source is a compressor, a Venturi pump, or another device capable of using compressed air to produce a vacuum or suction force, is positioned within a fluid line at a location downstream of the fluid source and upstream of suctions cups, for example, within hoist 220 or the trolley. The pneumatic fluid lines used to transmit pneumatics to the suction cups may be air hose reels or coil hoses. However, plate 242 need not include suction cup(s). Plate 242 may instead include a pivoting flap, slideable or pivotable hooks, a latch, a grapple, or another grasping device (hereinafter, along with the suctions cups, “a securement device”) capable of securing containers 10 to hoist 220.

A camera, or another imaging device, may be provided anywhere on loading/unloading device 200, for example, on plate 242 to capture images of the cargo area which may then be transmitted to the one or more processors to assist in controlling the automation of the loading/unloading device including movement of rail 218 along the beams in the x-direction, movement of hoist 220 along the rail in the y-direction, extension and retraction of plate 242 relative to the rail in the z-direction, and actuation of the securement device to grasp and/or release containers 10. Loading/unloading device 200 may further be designed in any manner contemplated in U.S. Pat. Appl. No. 63/238,431, the disclosure of which is hereby incorporated by reference in its entirety.

With continued reference to FIGS. 2-5, an example process of unloading inbound inventory using the loading/unloading device 200 will now be described. First, the base 212 of loading/unloading device 200 may be positioned at an edge of the loading dock adjacent to the rear of the trailer to position first beam 214 and second beam 216 within the cargo area 1 10 of vehicle 100. With loading/unloading device 200 in position, the locking mechanism may be actuated to prevent the rollers from unintentionally rolling, thereby fixing the loading/unloading device relative to the ground.

Rail 218 may then be moved along tracks 232 in the x-direction and hoist 220 may be moved along the rail in the x-direction to position plate 242 above a desired container 10. With hoist 220 in position, plate 242 may then be extended to engage and secure one or more container(s) 10 located underneath the plate as described above. Next, plate 242 may be retracted as the hoist is moved to a location above conveyor 50 before the plate is again extended to release the one or more container(s), individually or simultaneously, onto the conveyor.

The process of unloading containers 10 may continue until all the containers have been unloaded from the trailer. It will be appreciated that loading/unloading device 200 allows containers 10 to be unloaded “in levels” beginning with the containers closest to the ceiling of the semi-trailer and ending with the containers lying on the bed of the trailer. Unloading containers 10 in this manner sustains a foundation of containers throughout the cargo area 110 that support adjacent stacks of containers and, as a result, prevents the stacks of containers from toppling. Unloading the containers “in levels” is only possible because hoist 220 can pass over one or more stacks of containers that have not yet been unloaded. Put differently, loading dock personnel cannot unload containers from a semi-trailer “in levels” without stepping on or jumping over containers that have not yet been unloaded. Similarly, known robotic systems, have components that are prohibitively large and prevent the components from passing over stacks of a certain height thus necessitating that the containers be unloaded from the semitrailer in consecutive vertical stacks from the rear of the trailer to the front end of the trailer. As mentioned, when containers are unloaded in this manner, the unsupported stacks of containers are subject to toppling, which can result in damaged inventory and injury to the loading dock personnel.

While loading/unloading device 200 is primarily described herein as being gantry, the loading/unloading device may alternatively be an autonomously operated mobile robot with a grasping arm, or a similar autonomously operated robotic device.

After containers 10 have been unloaded from vehicle 100, the containers may be transported to inventory removal station 300, for example, via conveyor 50 or an Autonomous Mobile Robot (AMR). The Warehouse Management System (WMS) of warehouse 1000 may log information obtained from each inbound container as it is transported to inventory removal station 300. For instance, as shown in FIG. 6, each container 10 may pass through a CubiScan machine containing an array of cameras, scanners, and/or other sensors on its way to inventory removal station 300. As the containers pass through the tunnel, the scanners may scan an identify such as barcode, QR code, or RFID, provided on the container to determine the stock-keeping unit (SKU) contained within the container while cameras and/or sensors measure the dimensions and weight of the container. The information determined by the array of cameras, scanners, and/or sensors may be logged into the WMS and used to facilitate subsequent storage and fulfillment processes.

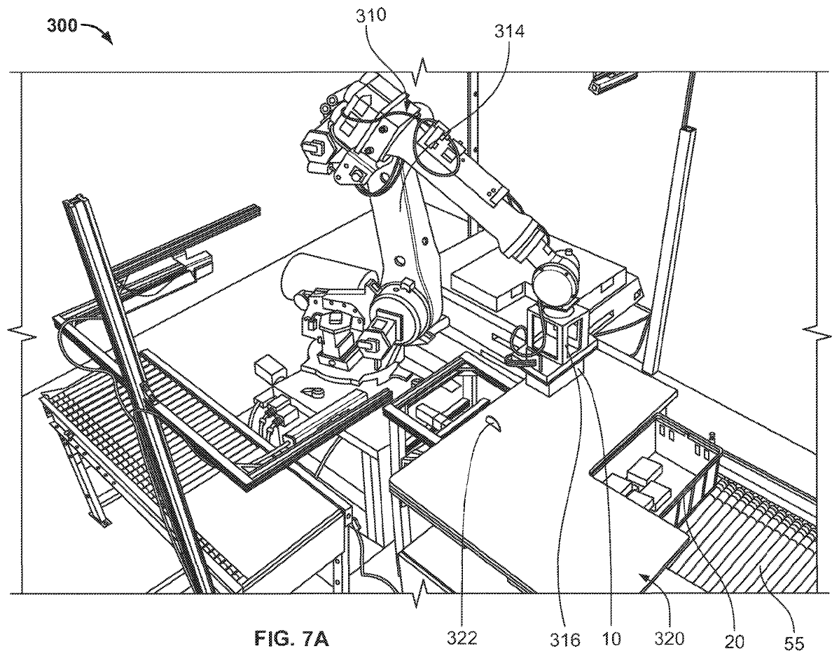

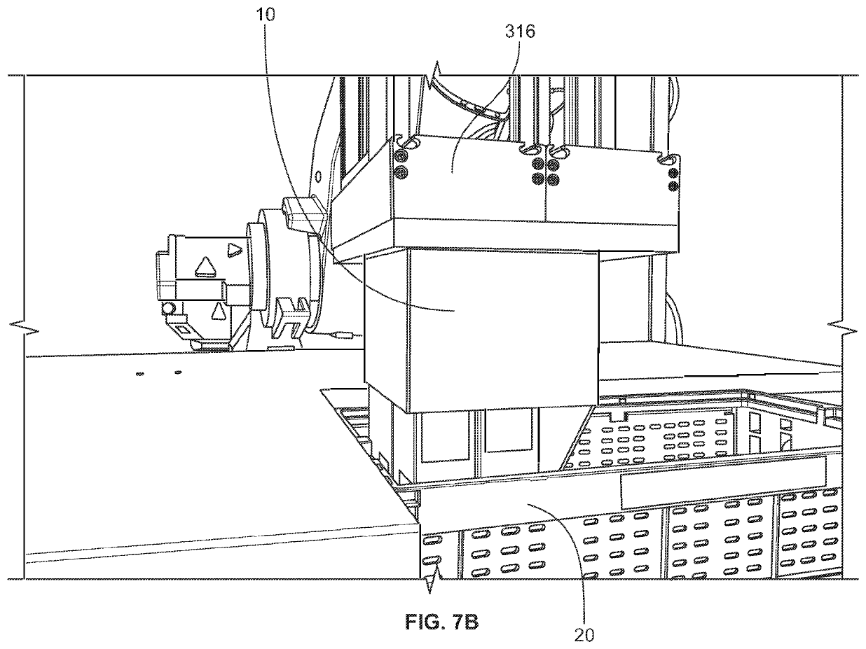

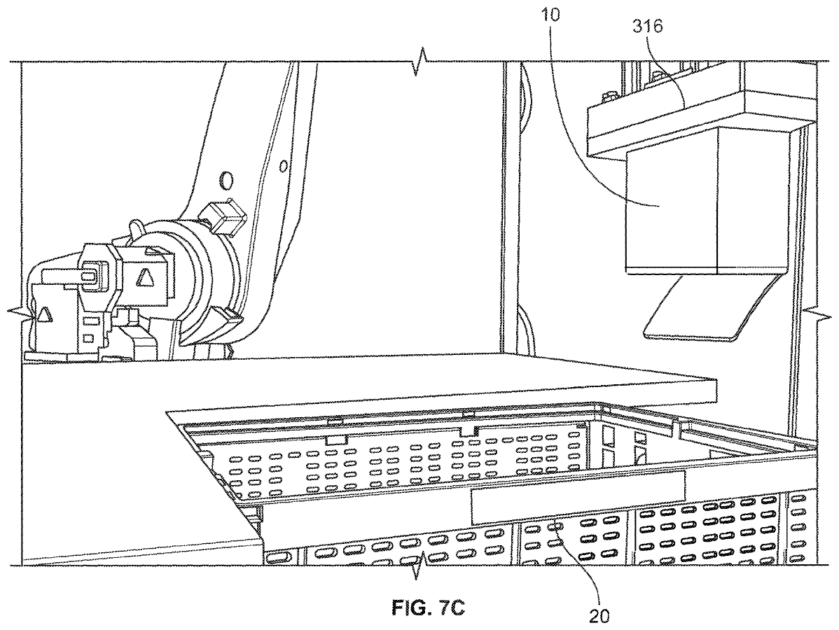

FIGS. 7A-7B illustrates an example inventory removal station 300 in the form of a container decanting station. The container decanting station may include a robotic manipulator 310 and a cutting table 320 arranged to “decant” container 10 and then transfer the inventory from the decanted container to a storage bin 20. Robotic manipulator 310 may include an arm 314 and a gripping head 316 coupled to the arm. Gripping head 316 may be a pneumatically actuated tool such as a suction cup. In some examples, gripping head 316 may be removably attached to arm 314, thereby allowing robotic manipulator 310 to autonomously swap one gripping head for a different gripping head that is better suited to manipulate containers 10 and/or particular inventory based on the size, weight, or other physical properties of the item that the robotic manipulator is tasked with manipulating.

Cutting table 320 may include a cutting device 322, such as a blade, protruding from a top surface of the cutting table. In this regard, robotic manipulator 310 may manipulate container 10 relative to cutting device 322 to cut one or more sides of the container. For example, robotic manipulator 310 may slide container 10 over the top surface of cutting table 320 in a manner that cuts three of the four edges of the bottom face of the container. As shown in FIG. 7B, robotic manipulator 310 may then slide container 10 laterally off cutting table 320 and over a storage bin 20 to dump the inventory into the storage bin. Specifically, storage bin 20 may be delivered to the container decanting station and positioned adjacent to cutting table 320 with the top of the storage bin located slightly below the surface of the cutting table. Thus, when robotic manipulator 310 slides container 10 off cutting table 320, the bottom face of the container will be forced open by the weight of the inventory and the inventory will fall into storage bin 20. Cutting three of the four edges of the bottom face of the container will keep the bottom face of container 10 attached to the body of the container such that the container can be disposed of as a single unit as shown in FIG. 7C. In some examples, robotic manipulator 310, or another robotic device, may then rearrange the inventory to densely pack the items within storage bin 20 and to ensure that no object protrudes over the top face of the storage bin.

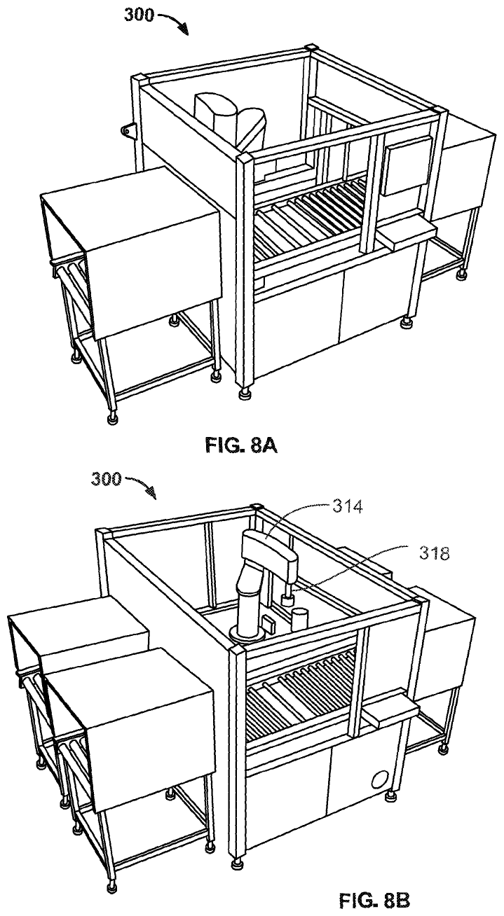

FIGS. 8A and 8B illustrate another inventory removal station 300 in the form of a container de-lidding station. The container de-lidding station may include a robotic manipulator 310 having an arm 314 provided with a cutting tool 318, such as a razor blade, a laser, or another cutting utensil, designed to “de-lid” container 10 or otherwise create an access opening through which the inventory items can be accessed. The access opening may be a face of the box (eg, the top face or a lateral face) or any other opening defined through at least one face of the container. The robotic manipulator 310, or another robot located at the de-lidding station or downstream thereof, may then pick the inventory items through the access opening of container 10 before packing the picked inventory items into storage bin 20. Alternatively, the inventory may be transferred to storage bin 20 by nesting the de-lidded or otherwise cut container 10 within the storage bin 20. After the inventory has been transferred to storage bin 20, the storage bin may be transported to storage and retrieval system 400 before it is slotted and stored within a storage structure. When storage bin 20 is slotted within the storage structure of storage and retrieval system 400, the WMS may record and log the location of the storage bin and, in turn, the SKUs stored therein, for subsequent retrieval.

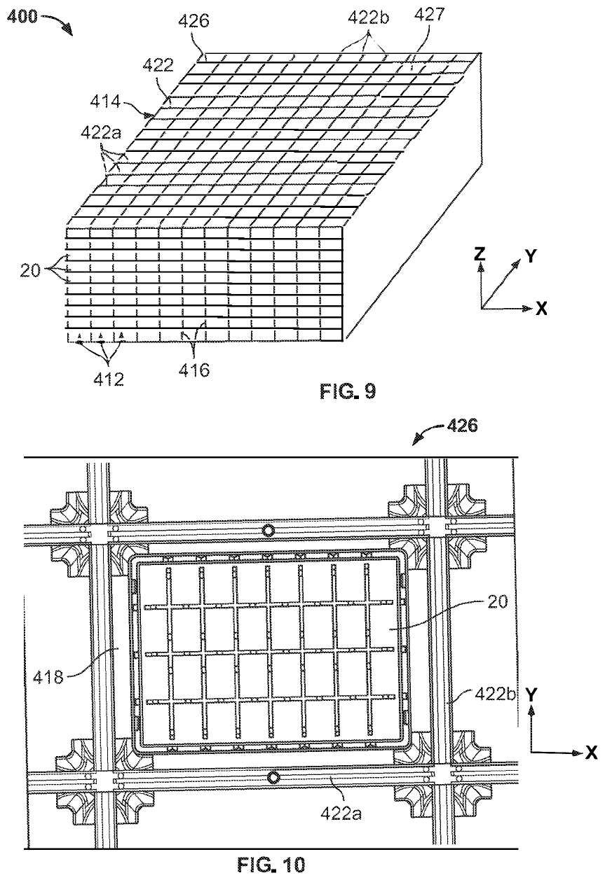

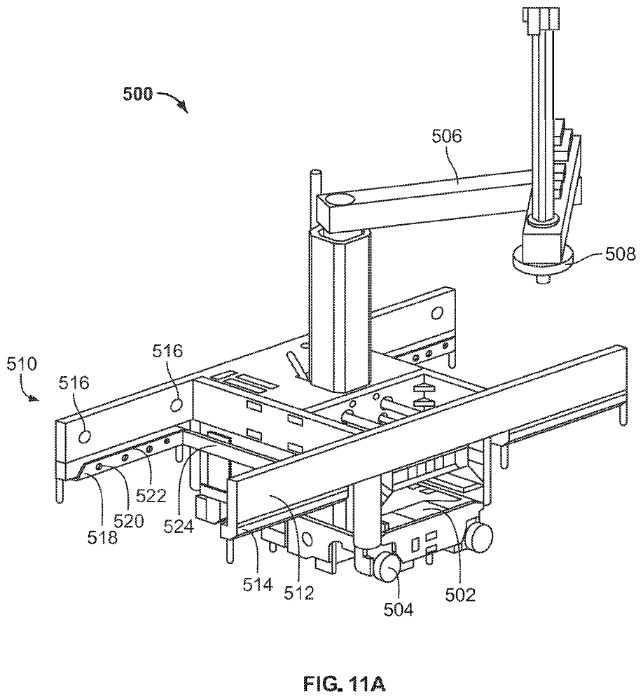

FIGS. 9 and 10 illustrate an example storage and retrieval system 400 including a gridbased storage structure designed to efficiently store a plurality of stackable storage bins 20 according to an embodiment of the present disclosure. Storage bins 20 are designed to nest within an upper surface (/.<?., rim) of another storage bin to form stacks 412 that can be arranged in a frame 414.

Frame 414 includes pillars 416 and a series of rails 422 arranged in a grid-like pattern at an uppermost level of the frame. For this reason, rails 422 are collectively referred to as a grid 426 which defines a plurality of grid spaces 427. Pillars 416 form shafts within which stacks 412 are housed. As a result, each stack 412 is located within the footprint of a respective grid space 427 (e.g., longitudinally underneath the respective grid space). FIG. 10 is a top elevation view of a single grid space 427. As shown in FIG. 10, the cross-sectional area of each shaft is slightly larger than the outer dimensions of storage bins 20 such that a small gap 418 extends entirely around the outer surface of the storage bins and between the outer surface of the storage bins and pillars 416.

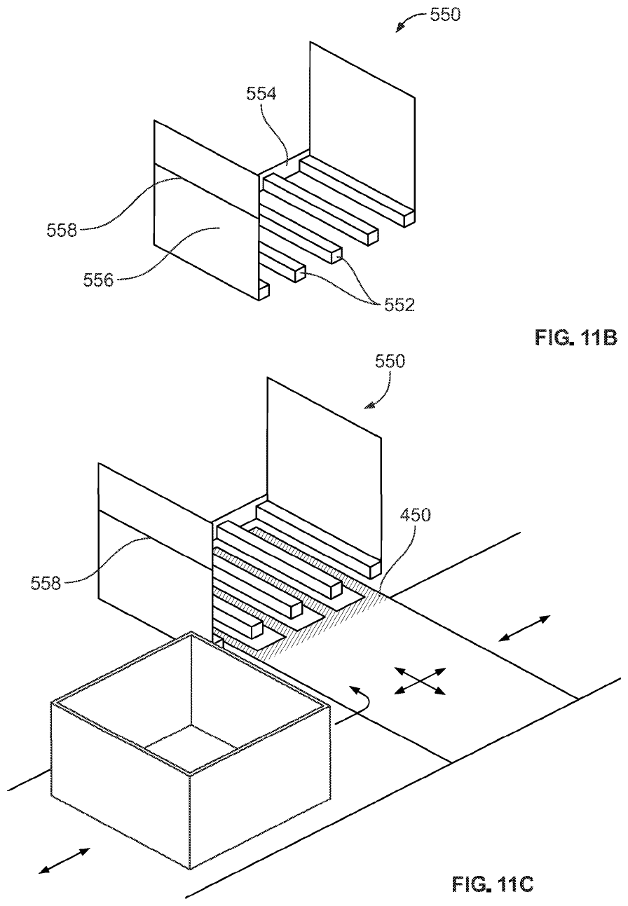

Each rail 422 may be extruded from a metal or metal alloy and formed with a double u-shaped track. The track provides a drive surface for robots 500 (shown in FIG. 11A) to move about grid 426 while picking and packing orders. A first set of rails 422a guides movement of robots 500 in a first direction e.g., the x-direction), and a second set of rails 422b, arranged perpendicular to the first set of rails, guides movement of the robots in a second direction (e.g., the y-direction). In this manner, rails 422 allow robots 500 to move laterally in two directions (in the x-direction and in the y-direction) across the top of frame 414 such that the robots can be moved into position above any one of the stacks 412 of storage bins 20.

With additional reference to FIG. 11A, robot 500 includes a communication interface to send and receive data between the robot and a remote computer, such as the WMS, enabling the remote computer to control movement and operation of each of the robots about grid 426. Robot 500 includes a body 502 and a wheel assembly 504 configured to guide movement of the body about rails 422. In one embodiment, wheel assembly 504 may include a plurality of wheels, a motor, and one or more transmissions (belts or linkages) operably coupling each one of the wheels to the motor. The orientation of the wheels is controlled by the motor and the one or more transmissions. More specifically, the motor is coupled to each one of the wheels, via the one or more transmissions, such that rotation of the motor simultaneously pivots the orientation of each one of the wheels. In this regard, the wheels may be concurrently pivoted between a first orientation in which each of the wheels is aligned with the first set of rails 422a and a second orientation in which each of the wheels is aligned with the second set of rails 422b (e.g., 90 degrees). A drive mechanism is associated with wheel assembly 504 to rotate the wheels and move body 402 along the rails in which the wheels are positioned.

In an alternative embodiment, the wheel assembly 504 of robot 500 may be constructed with first and second sets of non-pivotable wheels, one or more displacement mechanisms for lifting and lowering the first and second sets of wheels, and a drive mechanism, as is known in U.S. Pat. No. 9,682,822. Specifically, wheel assembly 504 may include a first set of non-pivotable wheels (consisting of a pair of wheels on the front of the robot and a pair of wheels on the back of the robot), a second set of non-pivotable wheels (consisting of a pair of a wheels on each lateral side of the robot), one or more displacement mechanisms for lifting the first set of wheels away from the first set of rails 422a and lowering the first set of wheels into engagement with the first set of rails, lifting the second set of wheels away from the second set of rails 422b and lowering the second set of wheels into engagement with the second set of parallel rails, and a drive mechanism to rotate the wheels along the rail to which the wheels are engaged.

The body 502 of robot 500 also includes a picking arm 506 equipped with an end effector 508 for picking and packing inventory items and/or one or more storage bin retrieval devices 510. Picking arm 506 is movable in at least three dimensions to allow end effector 508 to pick inventory items from storage bin 20 and to pack the picked inventory items into an order bin. End effector 508 may be a pneumatically actuated end effector such as a suction cup.

As shown in FIG. 11A, robot 500 includes two storage bin retrieval devices 510: a first storage bin retrieval device attached to a front of body 502 and a storage bin retrieval device attached to a back of the body. However, it is contemplated that robot 500 may include zero, one, two, three or four storage bin retrieval devices 510 and that the storage bin retrieval devices may be attached to the sides of body 502 in any arrangement.

Each storage bin retrieval device 510 includes a pair of support arms 512 and a grapple 514 designed to extract storage bins 20 from frame 414 and/or secure order bins to the body 502 of robot 500. Grapple 514 is suspended from support arms 512 by cables (not shown) which are connected to a winding mechanism 516 such as a spool, hoist, or winch. The cables can thus be wound and unwound to adjust the height of grapple 514 with respect to the support arms in the z-direction.

Grapple 514 includes a three-sided grapple frame 518 and pivotable flaps 520. The three sides of grapple frame 518 are formed by opposing grapple arms 522 and a connector 524. Grapple arms 522 and connector 524 collectively define an aperture. Each flap 520 is pivotable relative to a respective grapple arm 522 between a deployed condition in which the flap extends away from the grapple arm to which it is connected and into the aperture, and an undeployed condition in which the flap lies substantially flush against the grapple arm or is otherwise disposed within the footprint of the grapple arm. Movement of flaps 520 between the undeployed and deployed condition may be controlled by an actuator disposed within grapple 514 and configured to convert an electrical signal carried through the cables to motion of the flaps. When flaps 520 are in the undeployed condition, the aperture is larger than storage bin 20, allowing grapple 514 to be lowered into gap 418, and around a stack 412 of the storage bins, before the flaps are deployed and brought into engagement with an engagement feature such as a rib (not shown) on a side of the storage bin. In this manner, storage bin retrieval device 510 is arranged to extract one or more storage bins 20 in a single lift (e.g., the storage bin secured to grapple 514 and any storage bins stacked thereon).

As orders are received by warehouse 1000, the WMS will direct robot 500 to pick inventory items from storage bins 20 and pack the items into an order bin. After receiving pick and pack instructions from the WMS, robot 500 may secure an order bin to grapple 514 and use wheel assembly 504 to navigate to a desired location on grid 426. For example, if the desired SKU is housed in a storage bin 20 located at the top of a stack 412, wheel assembly 504 may drive along rails 422 to position the grapple 514 securing the order bin above a grid space located adjacent to the grid space within which the item is located. Once in position, end effector 508 e.g., suction cup) may be positioned within the storage bin to grasp the item. After the item has been grasped, picking arm 506 may be moved toward the order the container to pack the item.

On the other hand, if the desired item is housed within a storage bin 20 upon which other storage bins are stacked, the storage bin housing the desired item (e.g., the “target bin”) must first be extracted. To extract the target bin, robot 500 moves along rails 422 to position storage bin retrieval device 510 over the stack 412 housing the target bin. Grapple 514 may then be lowered into gap 418 and around stack 412 until the grapple is positioned around the storage bin nested within the target bin. With grapple 514 in position, flaps 520 may be deployed and brought into engagement with a rib, or another engagement feature, on a side of the storage bin to secure the storage bin to the grapple. With storage bin 20 secured to grapple 514, the winding mechanism may be wound to retract the grapple and to lift the storage bin and any storage bins located on top of that storage bin. The body 502 of robot 500 may then be moved to another location and each of the storage bins secured by grapple 514 may be temporarily placed on top of another stack 412. The storage bin retrieval device 510 may then be used to extract the target bin. With the extracted target bin secured to grapple 514, the picking arm 506 can pick the item from the target bin and pack the picked item into the order bin. The target bin and the storage bins that were temporarily displaced may then be returned to stack 412 in their original order. It will be appreciated that other robots 500 operating on grid 426 may assist in extracting the “non-target bins” (e.g., the bins stacked on top of the “target bin”), the “target bin,” or picking and packing the inventory item. Put differently, a single robot 500 need not perform each task necessary to pick and pack an item. That is, robots 500 operating on grid 426 may be assigned tasks from the WMS and work in conjunction with one another to fulfill one or more orders and increase overall fulfilment efficiency.

This process may be repeated until robot 500 has packed all the items relating to a particular order into the order bin. Robot 500 then may transfer the completed order bin out of storage and retrieval system 400. For example, the order bin may be transferred to an autopacking machine, an auto-sealing machine, or another staging area as will be described in further detail below.

In some implementations, the order bin may be structurally akin to storage bin 20 such that the order bin may be directly secured to the grapple 514 of robot 500. Order bins of this structure may be unpartitioned or partitioned into two or more sections each of which may correspond to a single order. In this regard, a single robot 500 can pick and pack several different orders. In other implementations, the order bin may be a vessel that is designed to be delivered to a purchasing consumer, such as a polybag or carton, thus avoiding the need to transfer the items from the order bin to another vessel downstream of order and retrieval system 400. Put another way, robot 500 may pack items directly into the vessel that is later sealed and labeled to form a package and delivered to the purchaser.

A traditional grid-based storage structure (not shown) utilizes I/O modules to transfer storage bins 20 into and out of the storage structure. More specifically, the grid includes one or more I/O modules consisting of hollow shaft that are not used for storing storage bins 20, but are instead used only to transfer the storage bins into and out of the storage structure. Traditional I/O modules may include a drawer, carousel or bin queuing mechanism (collectively “a protective mechanism”) to protect warehouse workers when loading replenished storage bins into the I/O module, and when unloading an empty storage bin from the I/O module. Put differently, storage bins 20 are retained in the protective mechanism such that subsequent storage bins lowered from above are not lowered on the hands of a warehouse worker operating below. The I/O module often includes expensive electronics and motors to control and actuate the protective mechanisms.

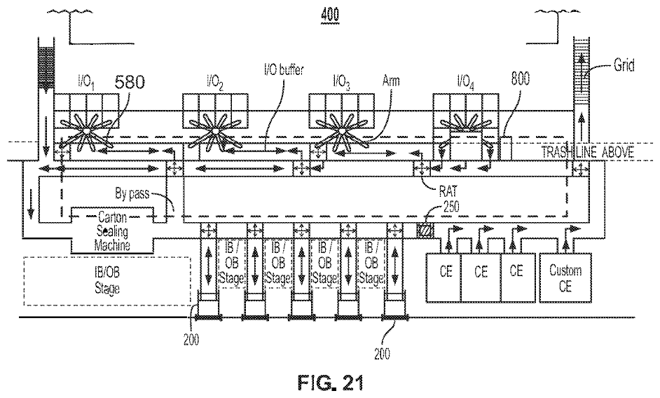

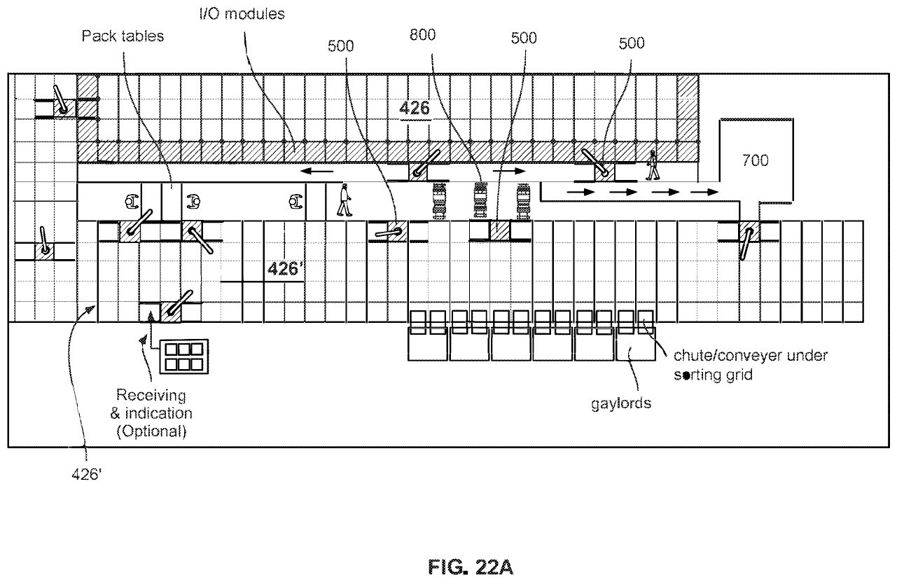

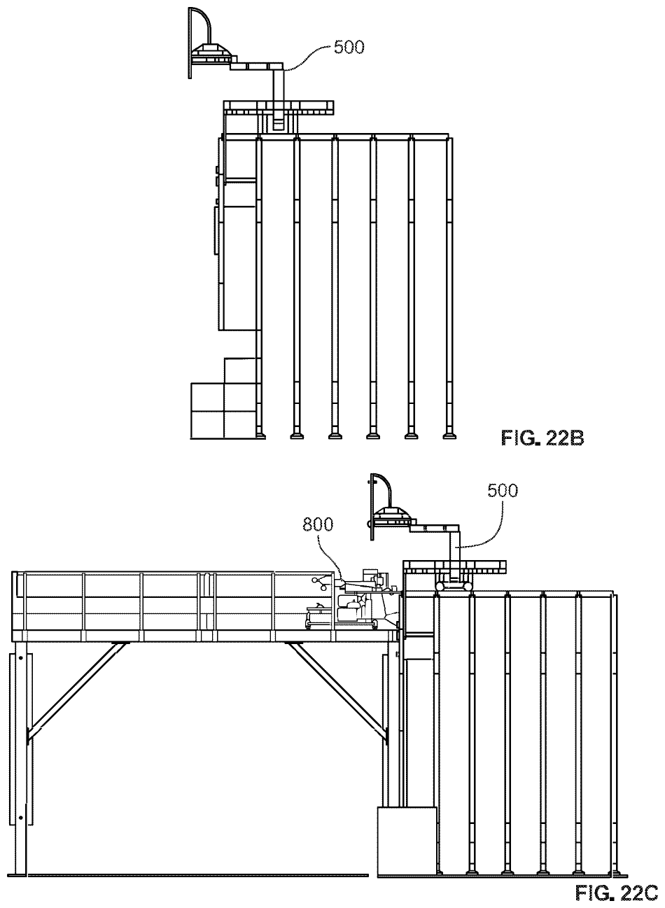

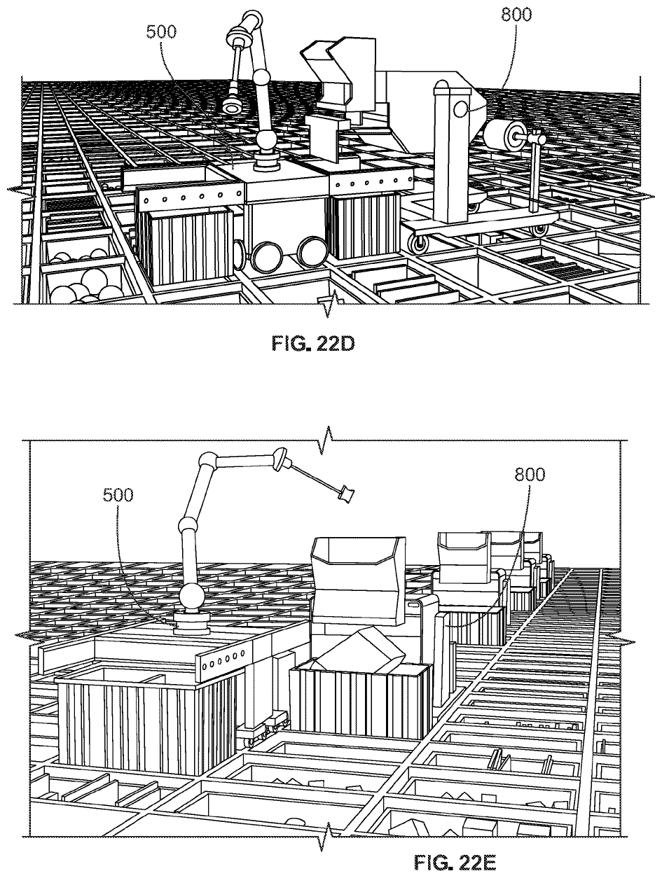

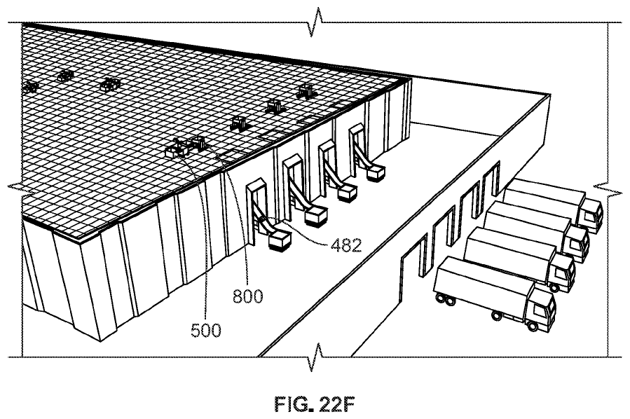

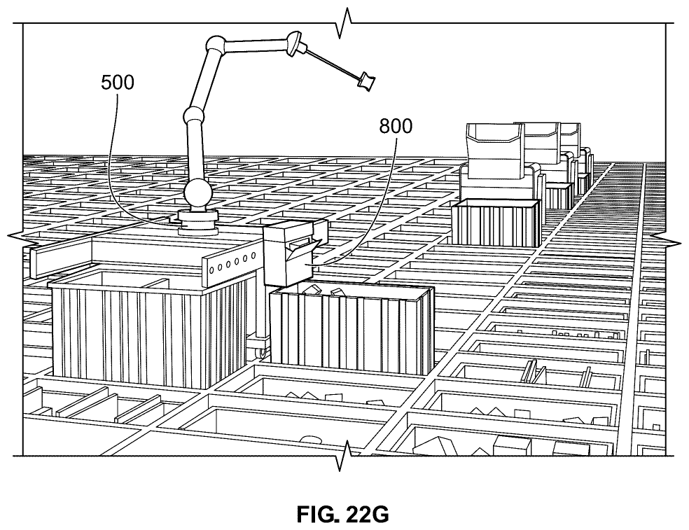

On the other hand, the grid-based storage structure of storage and retrieval system 400 may include a series of I/O modules arranged about the perimeter of grid 426. As shown in FIGS. 21 and 22A, each I/O module may be associated with a processing station at which a pick-and-pack robot 580 is provided, a manual processing station such as a pack table, and/or be associated with a conveyor, or another queuing device, for directing storage bins 20 and/or order bins into or away from the storage structure. Specifically, the in-module may be associated with an inbound conveyor for transferring replenished storage bins 20 (e.g., storage bins containing unordered inventory) into the storage structure and/or empty order bins into the storages structure. On the other hand, the out-module may be associated with an outbound conveyor for transferring empty storage bins 20 away from the storage structure for replenishment, or completed order bins (e.g., containing purchased items) out of the storage structure for further processing. In some examples, a majority of the grid spaces 427, or every grid space located along one or more sides of the grid, may be an I/O module. In this regard, the order bins and storage bins 20 may be rapidly transferred into and out from the storage structure and immediately presented to pick-and-pack robot 580 located at the processing station, thereby reducing the time it takes to present pick-and-pack robot 580 with a storage bin 20 containing items in which the robot is tasked with picking, As a result, the time in which pick-and-pack robot 580 is idle is reduced.

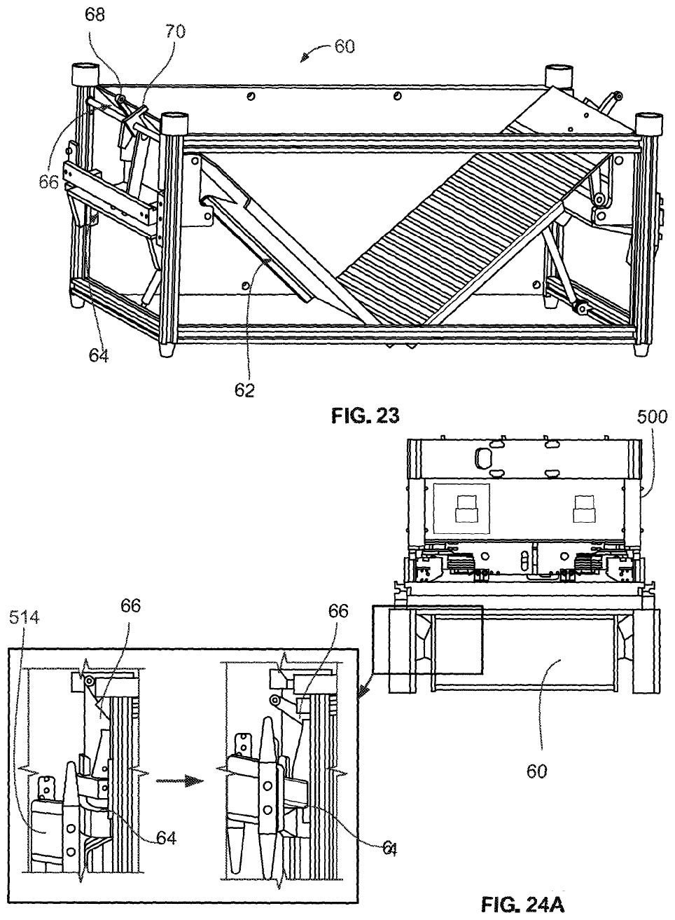

As shown in FIG. 22A, a sorting grid 426′ may be arranged adjacent to the storage structure of storage and retrieval system 400. Sorting grid 426′ may be formed substantially similar to grid 426 but at a lower height. Put differently, sorting grid 426′ includes perpendicularly oriented rails defining grid spaces that house stackable sorting bin 60 (shown in FIG. 23). Robots 500, with or without picking arm 506, may operate on sorting grid 426′ to assist in sorting items into individual order bins, sorting a plurality of packages 40 into gaylords for an outbound vehicle 100 (e.g., based on shipping company), and/or transferring storage bins 20 and order bins into and out from the storage structure.

FIG. 22B is a partial side elevation view of grid 426 illustrating an VO module. When a storage bin 20 is disposed within an in-module, the grapple 514 of robot 500 may be extended to secure the storage bin and then subsequently retracted to lift the storage bin above grid 426 before the robot slots the replenished bin within the storage structure as instructed by WMS. Robot 500 may alternatively lower empty storage bins 20 down the out-module for replenishment. It will be appreciated that when an order bin has the same structure as storage bin 20, robot 500 may lift an empty order bin from the in-module and lower a completed or partially completed order bin down the out-module in the same fashion. As shown in FIG. 22B, the pillars 416 defining the outer perimeter of VO module may not extend to the warehouse floor, or to the top of sorting grid 426′. Instead, such pillars 416 may be connected to the pillars defining an inside of the VO module via an inwardly extending support bridge. In this regard, robots 500 operating on sorting grid 426′ may position grapple 514 within the I/O module by driving underneath pillars 416 and inserting the support arms 512 of storage bin retrieval device 510 into the VO module. Since robots 500 are tasked with transferring storage bins 20 and order bins into and out from the storage structure of storage and retrieval system 400, the VO modules need not include protective mechanisms, such as drawers, or the expensive electronic and mechanical components that are associated with same. Instead, in some examples, robots 500 operating on grid 426 may utilize sensors, such as cameras on the grapple 514, to determine when a robot operating on the sorting grid 426′ is within the VO module so that it does not lower a storage bin 20 onto the robot below. In other instances, a central control system, such as the WMS, may transmit a ‘pause instruction’ to robot 500 when another robot is within the VO module, and subsequently transmit a ‘clearance instruction’ after the robot has departed the VO module and it is safe to lower the storage bin 20 or order bin.

When the order bin is an unsealed carton, it will be appreciated that the grapple 514 of robot 500 cannot directly grasp the carton. Instead, the carton must be indirectly secured to the grapple 514 of robot 500 by nesting the carton inside storage bin 20 or via an intermediate device, for example, a tray 550 as shown FIG. 11B. Tray 550 may include prongs 552 defining a bottom upon which the carton may seat, a rear retaining surface 554 such as a lip or a wall, and sidewalls 556 having an outer surface provided with a rib 558. Robot 500 may utilize grapple 514 to engage rib 558, thereby securing tray 550 in the same manner the grapple secures storage bin 20. The leading ends of prongs 552 may include a lip that retains the carton within tray 550 when the cardboard is seated on the prongs. Consequently, the carton may be indirectly secured to grapple 514 via tray 550.

The process of securing an order bin in the form of a carton to grapple 514 will now be described with reference to FIGS. 11C and 21. With tray 550 secured to grapple 514, robot 500 can navigate about grid 426 to a carton exchange location located at a perimeter of the grid. The carton may be delivered to the carton exchange location by a conveyor extending about at least a section of the perimeter of grid 426. The carton exchange location may include a Right-Angle Transfer (RAT) and carton exchange prongs 450 that extend over a grid space or an area adjacent to the edge of the grid. The RAT is thus arranged to transfer inbound cartons to carton exchange prongs 450. Each one of carton exchange prongs 450 includes a belt. The prongs 552 of tray 550 are sized and arranged to be inserted between the carton exchange prongs 450.

When robot 500 is tasked with picking up a carton, grapple 514 is extended which, in turn, lowers the prongs 552 of tray 550 underneath carton exchange prongs 450. At this time, the carton travels along the conveyor to the RAT which transfers the carton to the carton exchange prongs 450. The belts on each of the carton exchange prongs 450 guide the carton into engagement with the rear retaining surface 554 of tray 550. With the carton in position, grapple 514 is retracted to raise tray 550 above carton exchange prongs 450, which lifts the carton off carton exchange prongs 450 and seats the carton within the tray, thereby indirectly securing the cardboard to the grapple of robot 500.

One or more carton exchange locations may also be provided on an outbound side of grid 426 for releasing completed or partially completed cartons. When a robot is tasked with releasing a packed order bin in the form of a carton for outbound processing, grapple 514 is extended to lower the prongs 552 of tray 550 through the spaces between the carton exchange prongs 450 which will transfer the carton from the tray to the cardboard exchange prongs. The belts provided on carton exchange prongs 450 may then be driven to move the filled carton to the RAT which, in turn, transfers the carton to an outbound conveyor and away from storage and retrieval system 400 for further outbound processing.

It will be appreciated that when the order bin is a carton, or another end vessel to be shipped to the purchaser, the carton must be erected and transported to storage and retrieval system 400 before robot 500 begins the picking process, thereby allowing the robot to pack items for that order directly into the end vessel. In these implementations, a carton erector machine CE must be placed upstream of storage and retrieval system 400.

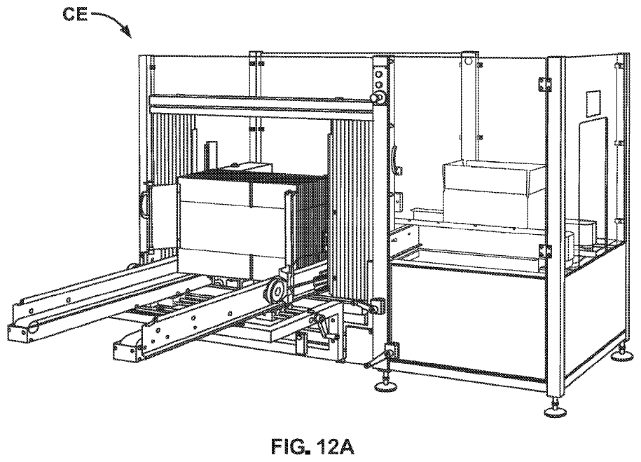

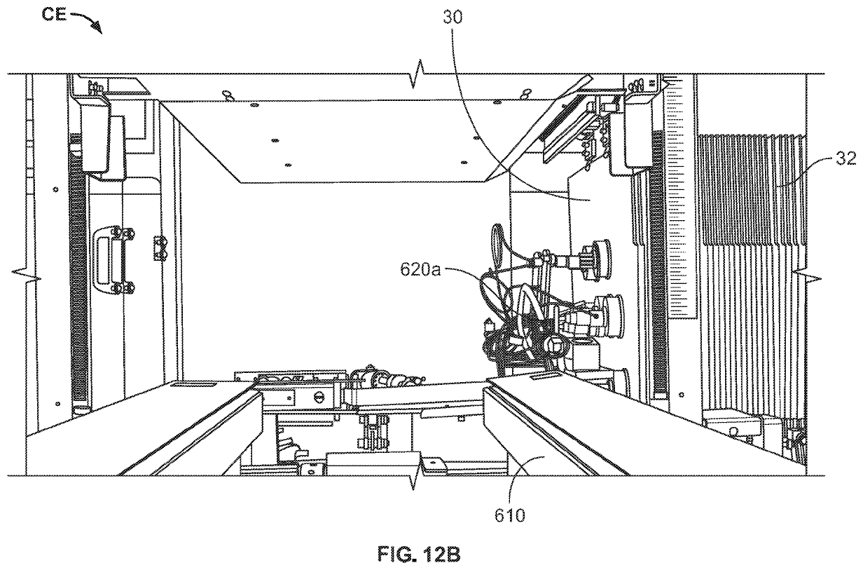

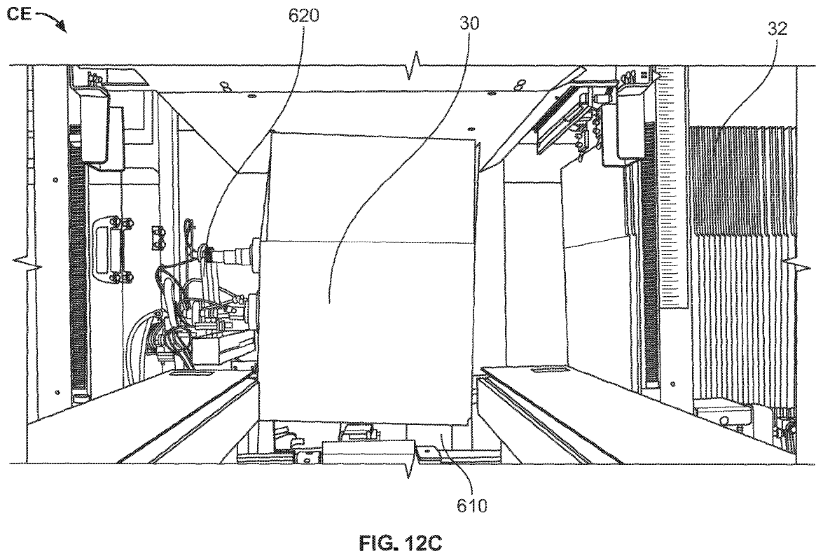

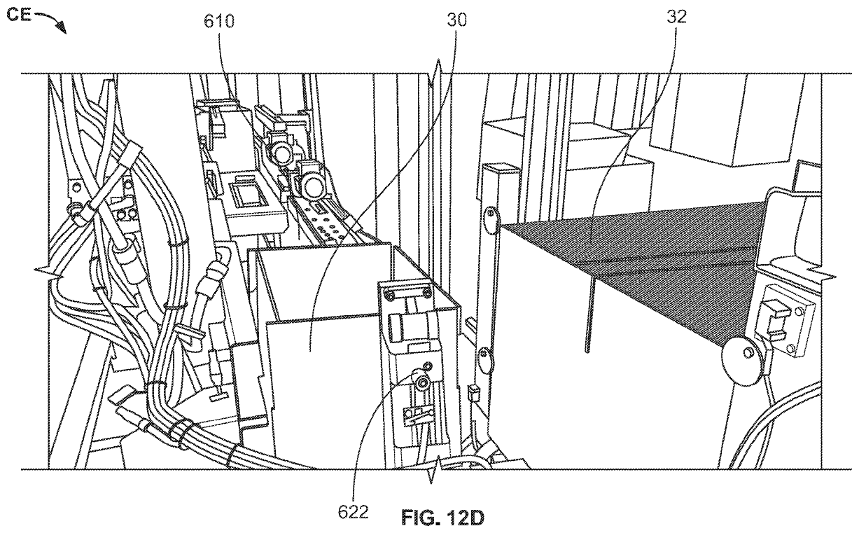

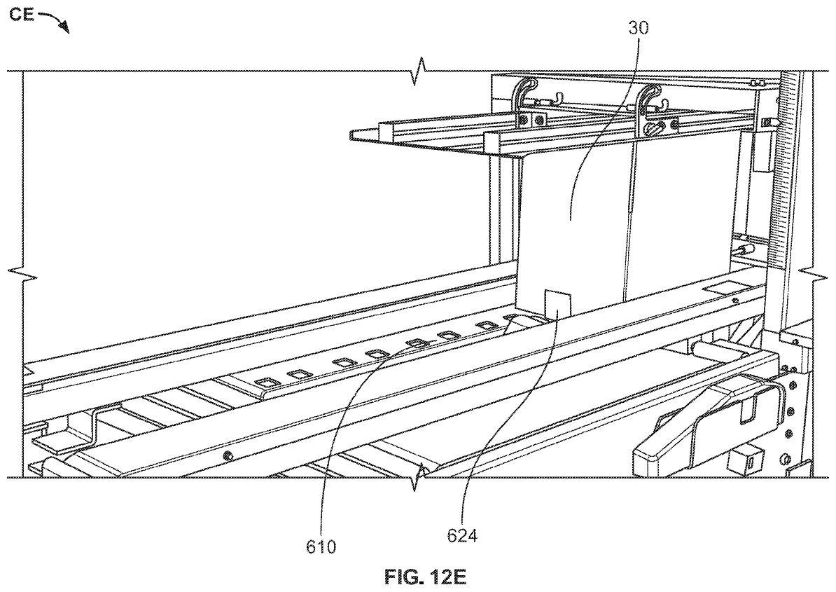

FIGS. 12A-12D illustrate an example carton erector machine CE designed to erect cartons of at least one predetermined size. That is, carton erector machine CE may be stocked with a set of uniformly sized packaging units 30, in a flattened or folded configuration, and the carton erector machine may draw one packaging unit at a time from the set of packaging units to substantially construct each cardboard. For example, packaging unit 30 may be substantially constructed into a box with the exception of one open face, preferably the top face.

Carton erector machine CE may include a track 610a, a gripping device 620, a directing arm 622, and a sealing device 624. A stack 32 of packaging units 30 may be provided to carton erector machine CE, and gripping device 620 may grip (eg, with suction cups) a face of the first packaging unit to draw the first packaging unit away from the stack while unfolding the first packing unit from the flattened configuration. In the unfolded configuration, packaging unit 30 may be passed along track 610 by gripping device 620, directing arm 622 or a combination of the same. After transitioning packaging unit 30 to the unfolded configuration, internal flaps of the packaging unit may fall to lay generally flat, or parallel, to the portion of track 610 beneath the packaging unit, and the packaging unit may then be passed over sealing device 624 to seal the bottom face of the packaging unit. Sealing device 624 may include a strip of adhesive that protrudes upwards from track 610 so that it contacts packaging unit 30 as the packaging unit is passed over the sealing device, thereby applying the adhesive along the bottom face of the packaging unit and securing the flaps together. The erected cardboard may then be sent to storage and retrieval system 400 to be used as an order bin as described above.

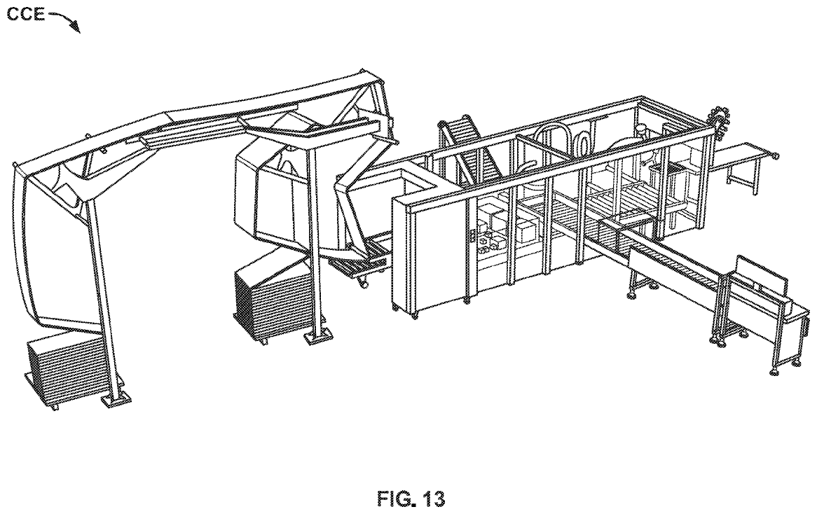

Alternatively, a customizable cardboard erector CCE, as shown in FIG. 13, may be used to create a carton customized in size to a particular order. Put another way, instead of erecting a box of a predetermined size, CCE unfolds and cuts a continuous sheet of cardboard which is subsequently folded and sealed to construct a cardboard having an open top face. Again, customized carton may then be sent to storage and retrieval system 400 to be used as an order bin.

After the order has been packed into an order bin in the form of a carton, the carton may be sealed and labeled by a carton sealing machine 900 provided downstream of storage and retrieval system 400. An example carton sealing machine 900, as shown in FIG. 18, includes a track 910, a folding device 920, and a sealing device 924. The carton may be passed along track 910 until the open flaps engage folding device 920, which will force the flaps to be folded downwards to close the top face of the cardboard. As the carton continues along track 910, the carton passes underneath sealing device 924 which applies a strip of adhesive along the top face of the carton to secure the flaps together and one or more shipping labels to the outside of the carton to form package 40 for outbound shipping. In some examples, sealing machine 900 may optionally apply branded tape, stickers or custom graphics, onto a surface of package 40. The aforementioned sealing machine 900 is merely exemplary and any other known sealing machine may be used.

In other implementations, items may be picked and placed into an auto-packing machine within storage and retrieval system 400, or alternatively, downstream of the storage and retrieval system 400. For example, pick-and-pack robot 580 located at a processing station may be tasked with transferring the items from an order bin to an end vessel such as a carton previously erected by carton erecting machine CE, a customizable carton erecting machine CCE, or an auto-packing machine for outbound delivery.

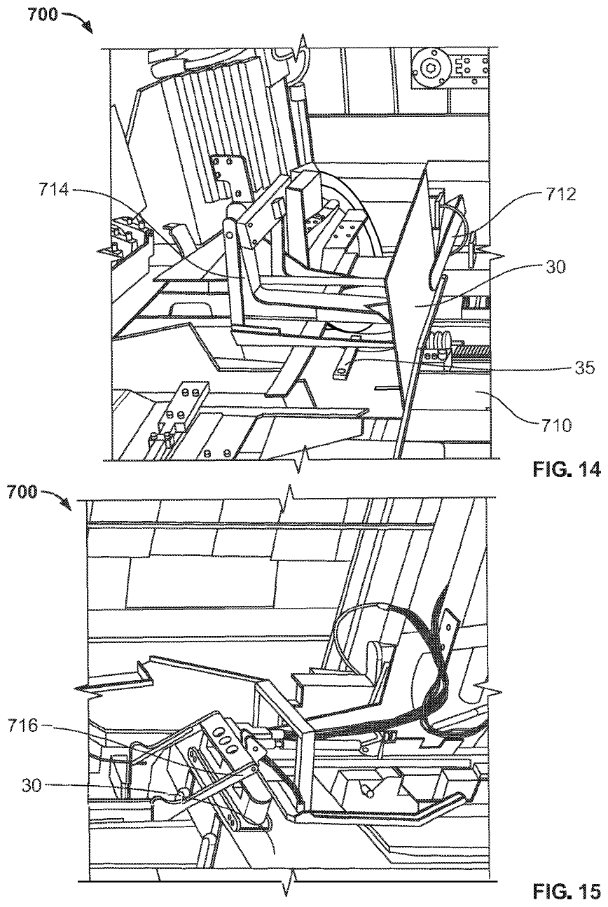

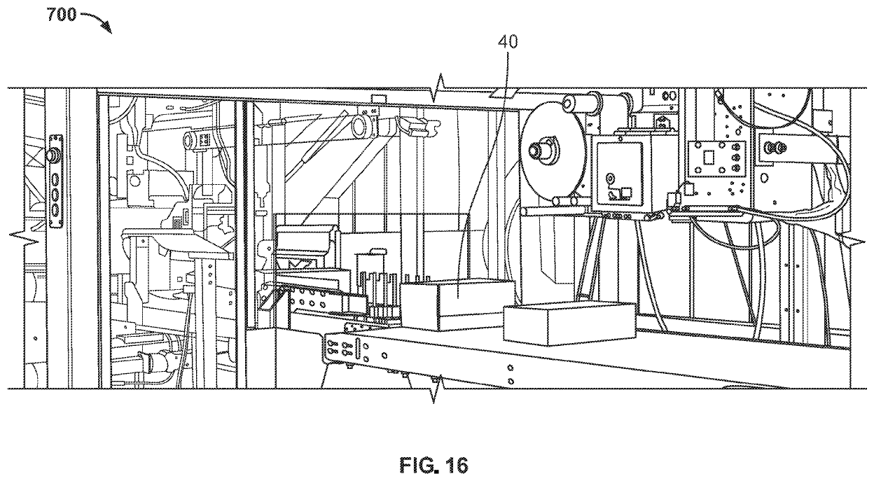

An example auto-packing machine in the form of a cardboard wrap machine 700 is shown in FIGS. 14-16. Carton wrap machine 700 includes a track 710 for conveying induced items and a variety of folding devices, such as a folding arm 712, a folding fork 714, and folding bar 716. The folding devices, which may be independently operated, work together to fold a packaging unit 30, such as a carton, around induced item(s), as they are conveyed along track 710, to form a customized package 40. Put differently, the size and shape of package 40 is customized to the size and shape of the items to minimize empty space within the package. As a result, more outbound orders can be transported by a single vehicle 100. For example, as shown in FIG. 14, an item, such as a frying pan 35, may be inducted into carton wrap machine 700, conveyed along track 710, and placed onto packaging unit 30. The folding devices may then work in concert to fold packaging unit 30 around frying pan 35, as shown in FIG. 15, to form a package 40 of a customized size as shown in FIG. 16.

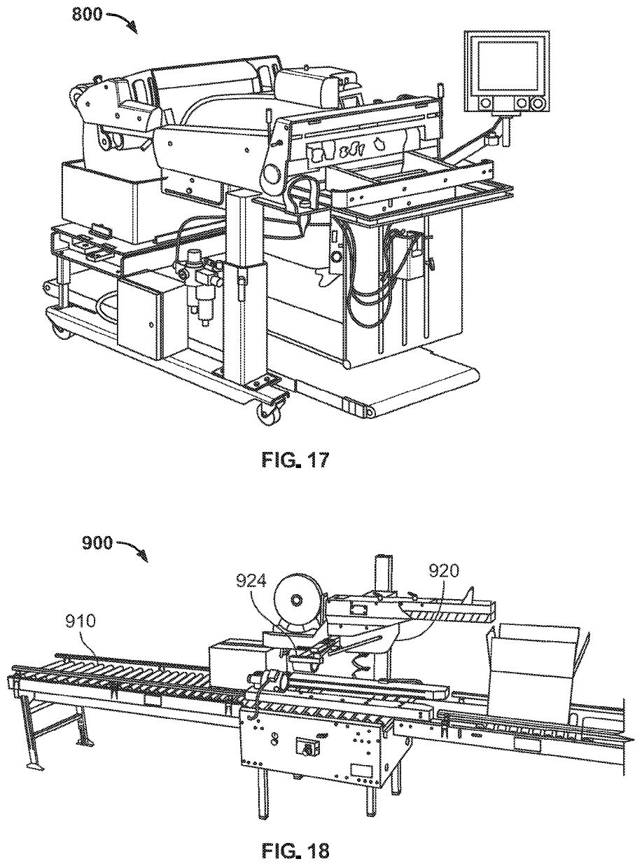

The auto-packing machine may alternatively be an auto-bagger 800 as shown in FIG. 17. Auto-bagger 800 is designed to open a bag formed of Polyethylene (a polybag) and to seal the polybag after an item, such as clothing, has been placed therein. Consequently, autobagger 800 may be referred to herein as an auto-packing machine and/or a sealing machine.

FIGS. 22C-22F illustrate examples in which an auto-packing machine is provided within storage and retrieval system 400. For example, the auto-packing machine may be positioned on grid 426 (as shown in FIGS. 22D-22F and FIG. 22G), or on tracks or a platform adjacent thereto (as shown in FIG. 22C), such that the auto-packing machine is arranged substantially at the same height as the grid. Specifically, the auto-packing machine may be positioned directly on grid 426 (as shown in FIGS. 22D-22F) or a compact auto-packing machine may be attached to the body of robot 500 (as shown in FIG. 22G) such that the auto-packing machine is indirectly disposed on the grid and designed to move with robot 500 about the grid. Accordingly, robot 500 may transfer picked items directly into a vessel that is designed to be shipped to an end consumer, for example, a polybag or an erected box. Advantageously, storage, retrieval, picking, unit consolidation, packing, and package sortation processes may all occur within storage and retrieval system 400. As a result, the order fulfillment stations discussed above may be reduced in size, or eliminated altogether, and the size of grid 426 may be increased relative to the size of warehouse 1000, thereby improving warehouse storage capacity and storage density. Furthermore, packing orders directly into the vessel that is shipped to an end consumer may eliminate a subsequent picking and packing step downstream of the storage and retrieval system 400, which may also eliminate downstream scanning and sorting steps as will be described in further detail hereinafter. Put differently, the systems shown in FIGS. 22C-22F allows robots 500 to pick items, consolidate the picked items, pack, and sort orders into outbound gaylords without scanning the picked items or outbound packages 40, and thus, eliminate the need for expensive scanners.

An example pick-and-pack process, in the form of an auto-bagging process, may include the following steps. In this example, robot(s) 500 may pick items based on a customer order into an order bin, for example, a partitioned order bin. In some examples, the partitions of the order bin may be movable, for example, slideable or pivotable as described in US Pat. Pub. No. 2022/0388774, which is incorporated herein by reference in its entirety. Put differently, an order bin may be partitioned into a plurality of sections and a first robot 500 may traverse grid 426 to at least partially pick one or more orders into a respective partition of the order bin, without comingling items of different orders within a respective section. For simplicity, if the order bin contains two sections, robot 500 may pick items relating to the first order into the first section and items relating to a second order into the second section.

Each section may contain all items for an order or only some of the items for the order. If each section contains all the items pertaining to an order, robot 500 can simply transfer each of the items pertaining to that order into auto-bagger 800 to form package 40 for outbound shipment. On the other hand, if the order bin contains only some of the items of an order, one or more other robots 500 operating on grid 426 may work in conjunction with the first robot to complete the order. This allows each of the robots 500 to pick portions of the order closer to that respective robot to reduce the total distance the robots must drive about grid 426. For example, if the first order contains three items, a first robot 500 may pick two items pertaining to that order into a first partition of the first order bin while a second robot may pick the third item into a partitioned section of a second order bin and the first and second robots may rendezvous at auto-bagger 800, or another location on the grid, to pack the complete order for outbound shipping as will be discussed in further detail hereinafter.

It will be appreciated that the robots 500 need not be present at the rendezvous, only the order bins. That is, in the previous example, the second robot may drop the second bin at a location on grid 426, such as adjacent auto-bagger 800, and the first robot may pick up the second order bin, consolidate the completed order into the first order bin or pack the completed order directly into the polybag of auto-bagger 800. Importantly, because items pertaining to an order are not coming in a particular section with items pertaining to another order, no scanning is needed between the picking and packaging processes. Instead, the one or more robots 500 and/or the WMS may track items from the time in which they are stored in storage bin 20 to the time they are deposited into the polybag to ensure that only those items pertaining to an order (and all items pertaining to that order) are packed into a polybag of auto-bagger 800.

In an alternative example, robot(s) 500 may pick items based on SKU into an order bin, for example, a partitioned order bin. In this example, robots 500 may traverse grid 426 and pick one or more items of a first SKU into a first section of a first order bin and one or more items of a second SKU into a second section of the first order bin. A second robot 500 may operate in the same manner to pick one or more items of a third through sixth SKU into distinct sections of a four-way partitioned order bin. In this example, the first and second robots may rendezvous at auto-bagger 800 to pack items into a polybag of auto-bagger 800 as complete orders. To continue with this example, a first order may include two items of a first SKU, and one item a third SKU; a second order may include one item of a fourth SKU; and a third order may contain one item of second SKU, one item of a fifth SKU, and one item of sixth SKU. The first and second robots may rendezvous at auto-bagger 800 and pick and pack items into a polybag as appropriate to complete the order and form the three packages 40. That is, robots 500 may pick two items of the first SKU into a polybag and a one item of the second SKU into the polybag before auto-bagger 800 seals the first order. The second and third orders may then be fulfilled in a similar manner.

It will be appreciated that either the first or the second robot, a combination of the first and second robot, or another robot 500 altogether, may pack the items into auto-bagger 800. Importantly, because different SKUs are not coming within a partition, no scanning is needed between the picking and packaging processes. Instead, the one or more robots 500 and/or the WMS may track each SKU from the time in which they are stored in storage bin 20 to the time they are deposited into the polybag to ensure that only those SKUs pertaining to an order (and all SKUs pertaining to that order) are packed into a polybag of auto-bagger 800.

In yet another example, robots 500 may employ a combination of the foregoing: order picking and SKU picking. For example, if an order contains a first SKU, a second SKU and a third SKU, robot 500 may utilize order picking to pick the first and second SKU into a first section of a first order bin and rendezvous with a second robot carrying a second order bin having a partition containing only items of the third SKU. Either the first robot, the second robot, or another robot 500 may consolidate the third SKU into the partitioned section of the first order bin, or pack the first, second, and third SKUs directly into a polybag of auto-bagger 800 to form package 40. Again, because items of different orders (other identifiable single SKUs) are not commingled into a single section of an order bin, downstream scanning to determine product identity or order identity is not necessary as will be further elaborated hereinafter. This reduces tact time and increases accuracy.

With all items pertaining to a completed order disposed within the one or more order bins, robot(s) 500 may drive to a location on grid 426 adjacent auto-bagger 800 and optimally position the one or more order bins within a workspace of the picking arm 506 of robot(s) 500 and auto-bagger 800. Robot(s) 500, or WMS, may then transmit order information (e.g., the order ID) to auto-bagger 800 which may use that order information to print a shipping label or barcode that is applied to the outside of the polybag. Based upon the order ID and, in conjunction with the vision system of robot(s) 500, auto-bagger 800 may optionally alter the opening of the polybag to assist robot(s) 500 in depositing each of the ordered items. Next, the one or more robots 500 may use picking arm 506 to pick each of the items pertaining to a first order and deposit those items into the open polybag of auto-bagger 800. After the robot(s) 500 have placed the items into the polybag, auto-bagger 800 may seal the polybag to form package 40. In other scenarios, the label may be applied to the outside of the polybag after robots 500 have placed the items into the polybag to form package 40.

Polybag package 40 may then be dropped directly back into the order bin secured to the grapple 514 of robot 500 (FIG. 22D). Alternatively, package 40 may be dropped into another vessel disposed underneath auto-bagger 800 (FIG. 22E and FIG. 22G) before it is grasped by robot 500. In either scenario, the picking arm 506 of robot 500 may re-arranged packages 40 into an appropriate vessel based on requested outbound shipping company. This process may continue until several orders have been packed, sealed, labeled, and sorted into a vessel, such as an order bin or a sorting bin 60 (discussed in further detail below), so that the orders may be transferred directly or indirectly to another area of the warehouse, for example, a gaylord for outbound shipping.

Again, this process can eliminate all scanning within storage and retrieval system 400 and downstream thereof. Nevertheless, in some instances, the packages may be weighed by a load cell of robot 500, for example, a load cell associated with the picking arm 506 or the grapple 514 of the robot, or a scale located downstream of the storage and retrieval system to compare the actual weight of the package to the expected weight of the package to confirm that the package contains the correct items and/or confirm that the shipping label indicates the correct weight.

After packages 40 have been sorted into bins based upon outbound shipping company, the bins may then be lowered down the TO module and transferred into a gaylord for outbound shipping as shown in FIG. 22C. Alternatively, if packages 40 are to be transported to different docks, for example, for shipment by different carriers, the one or more robots 500 may drive to a location on the grid containing outbound chutes 482 as shown in FIG. 22F. Each chute may extend from grid 426 to a different gaylord, staging area or transporting means (conveyor, AMR, etc.), and the one or more robots may deposit the sealed packages onto the appropriate chute 482 using picking arm 506 or sorting bin 60 (discussed below), to sort the packages into an appropriate gaylord, staging area or transporting means (conveyor, AMR, etc.) for outbound shipping. For example, one robot 500 may be tasked with picking items into auto-bagger 800 while a second robot securing an order bin, or sorting bin 60, may be arranged underneath the auto-bagger to receive one or more sealed packages 40. Upon receiving the one or more packages 40, the second robot may be dispatched to deposit the package(s) into an appropriate chute while a third robot may position an order bin or sorting bin 60 under the auto-bagger 800 to receive subsequent packages. In this regard, robot 500 can continuously pick orders into auto-bagger 800 while the one or more other robots sort packages to increase throughput.

Although the above example describes packing items into a polybag of auto-bagger 800, it will be understood that items may alternatively be packed directly into an earlier erected carton within storage and retrieval system 400 in the same manner without scanning the items. After the orders have been packed into an erected carton, the vessel may be sent out of storage and retrieval system 400, for example, via an I/O module to sealing machine 900, before the sealing machine seals the carton and applies a label to form package 40. Alternatively, consolidated orders, contained in an unpartitioned or partitioned order bin, may be transferred out of storage and retrieval system 400 to carton wrap machine 700, which may subsequently wrap a customized carton around the order item(s), seal, and label the carton to form package 40. The consolidated orders may be transferred out of storage and retrieval system 400 while disposed in an order bin or without the order bin. For example, the consolidated order may be picked from a partition of the order bin and placed on a chute which may transfer the consolidated order from storage and retrieval system 400 to a carton wrap machine. Still yet, earlier picked items pertaining to an order may be transferred out of storage and retrieval system 400, for example, via a chute or conveyor and into a sorting system or into a vessel located outside of the storage and retrieval system and designed to be shipped to an end consumer. In one example, the vessel may be a cardboard or a box. After all items relating to that order have been transferred into the vessel, the vessel may be transferred to the sealing machine for outbound shipment.

Returning now to FIG. 22A, auto-bagger 800 may alternatively be disposed on the floor of warehouse 1000, or on sorting grid 426′. In this manner, pick-and-pack robots 580 operating at a processing station, or robots 500 operating on sorting grid 426′, may pick at least some of the items pertaining to an order into auto-bagger 800. Pick-and-pack robot 580, or robots 500, may then deposit the polybag package 40 into a sorting bin 60.

Similarly, carton wrap machine 700 may be disposed on the floor of warehouse 1000, or on sorting grid 426′, adjacent to the storage structure of storage and retrieval system 400. After items pertaining to a particular order have been picked into a partitioned order bin, robot 500 may slide or otherwise move one of the partitions of the order bin to tightly condense the items. Next, robot 500 may lower the order bin down an I/O module and into a carton wrap machine 700 before a bottom of the order bin is opened and the carton wrap machine wraps a carton around the ordered items to form package 40. Alternatively, after the order bin has been lowered down an I/O module, a robot such as robot 500 or pick-and-pack robot 580, may pick items from the order bin into carton wrap machine, or into another tote configured to interact with the carton wrap machine, before the carton wrap machine wraps a carton around the ordered items to form package 40.

FIG. 23 is a perspective view of sorting bin 60 that may be actuated by the grapple 514 of robot 500 between a closed condition in which packages 40 are retained within the sorting bin and an open condition in which the packages may be deposited from the sorting bin into to Gaylord. The exterior of sorting bin 60 is formed of four side walls, an open top, and an openable bottom 62. In one example, the openable bottom may be in the form of bomb bay and include hatch doors that naturally sit in a closed condition via a biasing member such a spring. As shown in FIG. 23, sorting bin 60 may further include a trigger 64 and a hammer 66. Trigger 64 may include a latching mechanism that deploys the hammer 66 when the grapple 514 of robot 500 engages and lifts sorting bin 60. Hammer 66 may include a track roller 68 designed to interface with a bottom surface of the support arm 512 of storage bin retrieval device 510, and an opposing cam end 70 that interfaces and deploys the hatch doors when track roller 68 contacts the bottom support of the support arm.

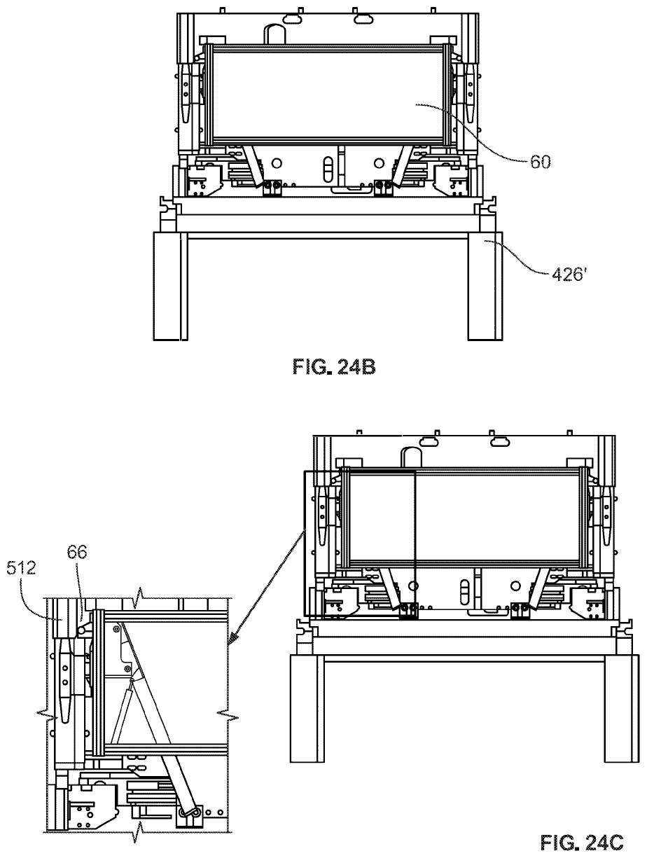

An example process of sorting polybag packages 40 into individual gaylords will now be described with reference to FIGS. 24A-24C. First, robot 500 may drive about sorting grid 426′ to position grapple 514 over a sorting bin 60 it is tasked with grasping. The grapple 514 of robot 500 may then be lowered about sorting bin 60 before flaps 520 are deployed and brought into engagement with trigger 64. As sorting bin 60 is lifted from a stack of sorting bins, trigger 64 deploys hammer 66 as shown in FIG. 24A. Then, as shown in FIG. 24B, the grapple 514 of robot 500 may extract sorting bin 60 to a height in which the hatch doors are located above the sorting grid 426′, without winding the grapple entirely back to its home position. With sorting bin 60 raised above sorting grid 426′, robot 500 may drive about the sorting grid to an appropriate location (eg, above another sorting bin, a gay lord, or a chute 482 extending to a gaylord). Once in position, the sorting bin 60 may be further raised such that the track roller 68 of hammer 66 engages a bottom surface of support arms 512 such that the opposing cam end 70 opens the hatch doors to deposit the contents of sorting bin 60 into another sorting container, a chute 482, or directly into an appropriate gaylord. The gaylords may be disposed adjacent a dock door of the warehouse, or moved by a conveyor, forklift, pallet jack, AMR (Autonomous Mobile Robot) or another manual or automated system to a location adjacent a dock door before the packages are loaded into a vehicle by loading/unloading device 200. It will be appreciated that sorting grid 426′ may not only act as a sorting location but also may be used to temporarily store partially completed or completed orders, and thus, may act as a buffering zone so as not to create a log jam at a loading dock. While sorting bin 60 is described above in connection with sorting grid 426′, it will be appreciated that sorting bin 60 may also be utilized by robot 500 on grid 426 to deposit orders into a chute 482 destined for a particular gaylord or another area of the warehouse.

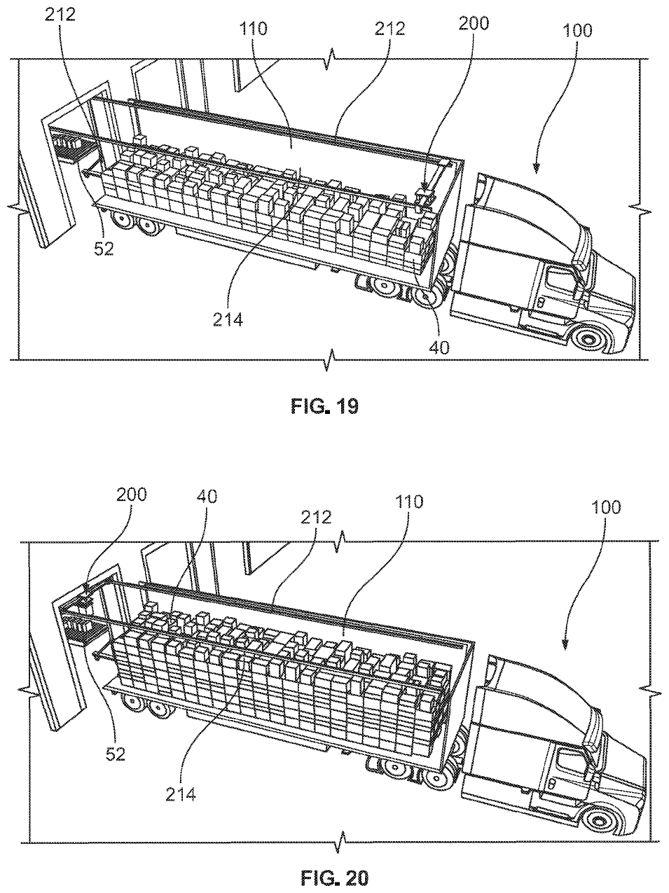

With reference to FIGS. 19-20, an example process of loading packages 40 into a semi-trailer using loading/unloading device 200 will now be described. With packages 40 located underneath loading/unloading device 200, plate 242 may be extended to engage and secure one more package(s) as described above. Hoist 220 may then be moved to a desired location within the semi-trailer by sliding the rail along the beams in an x-direction and by sliding the hoist along the rail in an y-direction. After hoist 220 has been positioned within an x-y plane as desired, plate 242 may be extended in the z-direction before the package(s) are released.

The process of loading one or more packages may continue as the packages are loaded in levels. In other words, the packages may be loaded in one or more rows along the length of the vehicle and one or more rows along the width of the vehicle, with little to no space between adjacent rows, before the packages are stacked on top of one another. Again, loading the packages into the semi-trailer in this manner builds a stronger foundation for the subsequently loaded packages, improves packing density of the semi-trailer, and expedites the stacking process, as shown in the arrangement of FIG. 20.

After each of the packages have been loaded into the semi-trailer, loading/unloading device 200 may be relocated to another dock for immediate use, stored inside the dock for future uses, or slid within cargo area 110 of the semi-trailer trailer and transported along with the cargo to the destination location where the loading/unloading device can be utilized to load the packages.

FIGS. 21 and 22A are detailed schematics illustrating the various automated order fulfillment systems described herein. With specific reference to FIG. 21, an example order fulfillment processes will now be described. When inbound inventory arrives at warehouse 1000, loading/unloading device 200 unloads containers 10 from vehicle 100. Containers 10 are then transported by conveyor 50, or an AMR, through CubiScan 250 to an inventory removal station 300, such as a container decanting station or a container de-lidding station, where an access opening will be cut through the container. In one example, the access opening may be removing the lid of the container. Inventory removal station 300 may be located along a buffer line corresponding to I/O modules of storage and retrieval system 400, where a robotic manipulator 310 (or another robot) will transfer the items into storage bin 20 by dumping the inventory into the storage bin, picking and packing the inventory into the storage bin, or by nesting the cut container into the storage bin. In the event inventory is dumped or picked and packed from container 10 into storage bin 20, robotic manipulator 310 (or the other robot) may dispose of container 10 onto a trash line, which may be elevated above or below the buffer line or the conveyor, to transfer the empty container to a trash area. After the inventory items have been transferred to storage bin 20 and the storage bin has been placed in the I/O module, the storage bins are secured to the grapple 514 of robot 500 and lifted to a location above grid 426. Robot 500 may then immediately slot storage bin 20 within the grid-based storage structure as instructed by the WMS or pick one or more items from that storage bin 20 and pack the picked items into other storage bins to replenish those bins.

A carton erector machine CE and/or a customizable carton erector machine CCE may also be provided upstream of storage and retrieval system 400. Cartons erected from carton erector machine CE and/or a customizable carton erector machine CCE may be used in two ways: (1) the cartons may be transported to grid 426 and used by robot 500 as order bins; or (2) transferred to a processing station. In the first example, when an order is received, robot 500 may indirectly secure the desired carton to grapple 514 using tray 550 before crossing about the grid and picking and packing items pertaining to that order directly into the carton. Robot 500 may then deliver the completely packed, or partially packed order, to the carton exchange location located at an outbound side of grid 426. The carton may then be transferred from tray 550 to carton exchange prongs 450, then to Right-Angle Transfer (RAT), and finally to the outbound conveyor which transports the cardboard to an outbound buffer line. If the order is complete, the order may immediately be transferred to the sealing machine. On the other hand, if the order is only partially complete, the carton may be sent to a designated processing station where pick-and-pack robot 580 finishes packing items to the order before the carton proceeds to the sealing machine.

Alternatively, in the second example, the erected cartons may be transferred to the buffer line corresponding to one of the processing stations adjacent the I/O modules. After one or more items of a particular order have been picked by robot 500 and placed into an order bin, the robot may transfer the order bin to an I/O module and out of the storage and retrieval system 400 to the processing station. Pick-and-pack robot 580 may then pick one or more items from the order bin and pack the picked items into the carton. After all of the items relating to a particular order have been packed into the carton, the carton may be ejected onto the conveyor for further outbound processing.

The outbound conveyor may, for example, transport the carton to sealing machine 900 which seals the carton and applies a label to form completed package 40. If, on the other hand, the auto-packing machine is an auto-bagger 800 located along the buffer line, the polybag may be transported via a by-pass conveyor to avoid sealing machine 900. In either scenario, completed packages 40 may be transported by the conveyor, or an AMR, to a designated dock door corresponding to an appropriate delivery vehicle 100 before the packages are loaded onto vehicle 100 using loading/unloading device 200.

With additional reference to FIG. 22A, the conveyor loop inside the dashed line of FIG. 21 may be replaced with sorting grid 426′ and/or one or more of the automated processing station may be replaced with a manual processing station such as a pack table. Robots 500 may traverse sorting grid 426′ to move storage bins 20 and/or order contains into and out from the storage structure of storage and retrieval system 400, between the various stations within warehouse 1000, and to sort packages 40 into appropriate gaylords for outbound shipping. While warehouse 1000 is described herein as not needing warehouse operators, it will be appreciated that warehouse workers may be utilized to supplement or replace pick-and-pack robots 580 or perform other fulfilment operations.

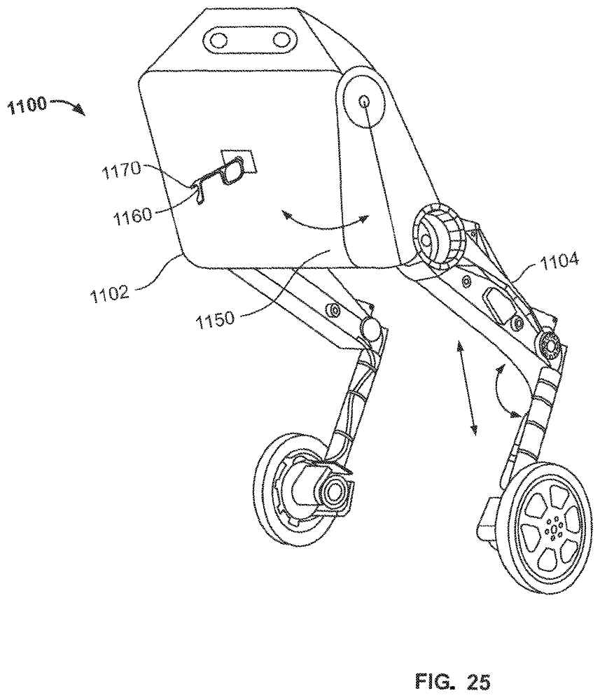

FIG. 25 illustrates an example delivery robot 1100 that can deliver packages 40 to a purchaser. Delivery robot 1100 may be deployed directly from the warehouse 1000 to deliver packages to locations proximate the warehouse 1000, or ride within vehicle 100 and be subsequently deployed once the vehicle reaches an appropriate destination. Delivery robot 1100 may include a body 1102 having a mobility assembly 1104, and at least one arm (not shown). The body of 1102 of delivery robot 1100 may be compact such that it is about the width of standard human. In this regard, delivery robot 1100 may be designed to move along congested sidewalks and walkways of any suburb or city. As shown in FIG. 25, the mobility assembly 1 104 of delivery robot 1 100 may include two or more legs each of which may optionally be provided with a wheel. The wheels of delivery robot 1100 may be used to drive the robot across a generally flat terrain such as bike lanes, sidewalks, and other pathways at an appropriate speed based upon the environmental conditions. The legs, on the other hand, may be used to step over obstructing objects, and/or to climb or descend stairs about the delivery route.

The one or more arms may be used to secure an order package. More specifically, each arm may include a hand designed to secure the order between the arms via a compressive force. The hand may be a friction enhancing nub formed from a silicone or rubber material having friction enhancing properties. In some embodiments, the nub may include protrusions, or an otherwise uneven surface, to further enhance friction and secure the order, or other features designed to retain package 40 in a passive maimer. However, the hand is not limited to a nub and may alternatively include gripping elements such as fingers or one or more suction cups.

As shown in FIG. 25, the arms may be replaced with a carrying cavity 1150 designed to carry package 40 within the body 1102 of delivery robot 1100. In this regard, carrying cavity 1150 protects package 40 from theft, environmental conditions and minimizes the area occupied by the combination of delivery robot 1100 and the package, allowing the delivery robot to nimbly navigate congested streets. In some examples, carrying cavity 1150 may be temperature controlled and thus designed to safely transport packages 40 containing perishable groceries. A suction cup or other securement device (not shown) may be disposed within carrying cavity 1150 for grasping packages 40. Carrying cavity 1150 may be transitionable between a closed condition in which the package is housed within the body 1102 of delivery robot 1100, and an open condition in which the package is dispensed from the body. As shown in FIG. 25, carrying cavity 1150 may include bomb bay doors, however, any other mechanism used to open and close the cavity may be utilized.

It will be appreciated that delivery robot 1100 is much less costly to manufacture without arms and/or hands. However, arms and hands provide advantageous functionality, such as the ability to press a keypad, open doors or drawers, or any function ordinarily performed by human arms. For this reason, the body 1102 of delivery robot 1100 may include a passive or underactuated device 1160. In one example, the passive or underactuated device 1160 may have a hook-like shape as shown in FIG. 25. The hook may define a recessed area designed to receive a horizontally positioned handle when the hook is located within a vertical plane. In this manner, delivery robot 1100 may engage a horizontal handle of a drawer before moving its body backwards to open the drawer. In some examples, the hook may be mounted to extend from the body in other orientations, such as a horizontal plane, so that the hook may be engaged with vertical handles to open doors in a similar manner. In other examples, the hook may be rotatably mounted to the body 1102 of delivery robot 1100 and configured to open a wide variety of features having handles. As shown in further detail, the hook may additionally include an end 1170 defining a rubber or silicon tip, which may be used to enter information on a touch screen or keypad to gain access to an area such as the lobby of a building. In this regard, the passive or underactuated device 1160 is designed to perform many of the functions of a human or robotic arm and hand, at a fraction of the cost.

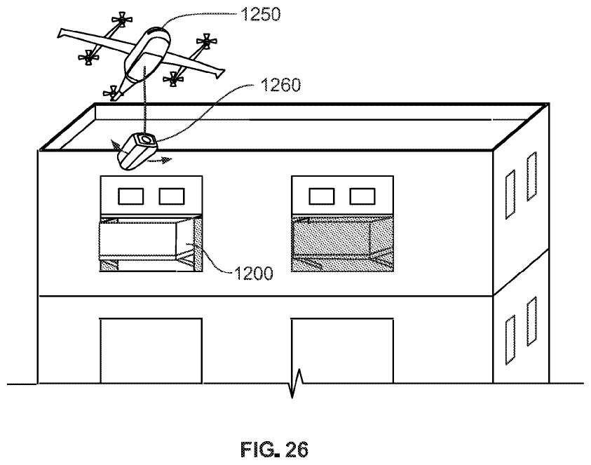

FIG. 26 illustrates a receiving locker 1200 secured to an interior surface of a windowsill. Receiving locker 1200 includes a bottom surface and at least three sidewalls. Put differently, the receiving lock has an open (or openable) lateral side facing the window of a residence. The top of receiving locker 1200 may be permanently open or designed with an openable face. Accordingly, a drone 1250 can secure a package 40 and carry the package from warehouse 1000, or vehicle 100, to deposit the package within the receiving locker 1200 through the open top or via a small chute. Drone 1250 may include wings and/or propellers and a clamshell-type cavity 1260 having a suction cup or other securement device (not shown) disposed therein for grasping packages 40. Clamshell-type cavity 1260 may be connected to a body of drone 1250 via an extendable and retractable rope and designed to transition between a closed position and an open position. In this regard, clamshell-type cavity 1260 may be lowered toward package 40 and then opened to expose its securement device which may be used to secure the package. With package 40 secured, the clamshell-type cavity 1260 may be closed about the package and lifted towards the body of drone 1250 for transportation to a drop-off destination such as receiving locker 1200.

In some examples, it may be desirable for receiving locker 1200 to have an openable top face to protect package 40 from theft or harsh environments. In such scenarios, a portion or an entirety of the top face may be manually or electronically moveable between closed and open positions. Alternatively, receiving locker 1200 may include a sensor such as a load sensor or a camera designed to detect when a package has been deposited into the receiving locker and an actuator to autonomously close the top when package 40 has been received. In other examples, the drone itself may send instructions to receiving locker 1200 after it has deposited package 40, instructing the receiving locker to close the top.

Multi-unit residences, including apartment complexes in urban areas may utilize shuttle sorters, such as those disclosed in US Pat. Pub. No. 2021/0188554, to sort packages delivered via ground transportation. Packages 40 may then be delivered via drones to deposit the packages into receiving locker 1200. Alternatively, the sorted packages 40 may be transported to another storage location within the residence where it may be locked in a locker or cubby for the resident. Alternatively, the shuttle sorters may be arranged on the roof or in other areas of the building to sort packages delivered by drone before being locked in a locker or cubby for the resident. In all instances, the building may notify the resident that a package 40 has arrived via text, email or resident portal.

The autonomous order fulfillment and delivery systems of warehouse 1000 described herein substantially automate the entire order fulfillment process and remove the need for any, or substantially all, human intervention. The compact flow between the systems also maximizes the percentage of the warehouse that can be occupied by storage and retrieval system 400, thereby improving the storage density of the warehouse which, in turn, reduces operating capital.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An order fulfillment system, including:
a storage and retrieval system, including:
a storage structure housing storage bins in stacks, the storage structure including vertical pillars supporting a first set of rails and a second set of rails extending perpendicular to the first set of rails, the first and second sets of rails collectively forming a grid defining a plurality of grid spaces such that each of the stacks are housed within a footprint of a respective grid space;
one or more robots operational on the grid, the one or more robots including:
a body coupled to a wheel assembly, the wheel assembly including a plurality of wheels and a drive mechanism arranged to move the body along the first and/or second sets of rails; and
a picking arm for placing inventory items directly into a vessel for outbound shipment to an end user; and
an auto-packing and/or sealing machine for sealing the vessel and forming a package,
wherein the auto-packing and/or sealing machine is disposed on the grid, or adjacent the grid and at a height that is substantially equal to a height of the grid.

2. The system of claim 1, wherein the auto-packing and/or sealing machine is an auto-bagger, and the vessel is a polybag.

3. The system of claim 2, wherein the auto-bagger is disposed on the grid.

4. The system of claim 2, wherein the auto-bagger is disposed adjacent the grid and at a height that is substantially equal to a height of the grid.

5. The system of claim 1, further comprising a plurality of chutes extending from the grid to a respective gaylord.

6. The system of claim 1, wherein the vessel is a cardboard.

7. The system of claim 6, further including a carton erector for erecting the carton, the carton erector being upstream of the storage structure.

8. The system of claim 7, further comprising a carton sealing machine located downstream of the storage structure, the carton sealing machine being arranged to seal the carton and form a package.

9. The system of claim 1, wherein the one or more robots further comprised a grapple suspended from support arms by cables connected to a winding mechanism to adjust a height of the grapple in a vertical direction, the grapple being arranged to secure the storage bins and a tray upon which a cardboard can be seated.

10. The system of claim 1, further including a loading/unloading device for unloading containers from a cargo area of a vehicle and/or loading packages into the cargo area of the vehicle.

11. The system of claim 10, wherein the loading/unloading device is an autonomous gantry, comprising:
a pair of beams extending in a first direction;
a rail extending between the pair of beams and movable along the pair of beams in the first direction; and
a hoist coupled to and movable along the rail in a second direction transverse to the first direction, the hoist including a plate having a securement device, the plate being movable in a vertical direction relative to the rail between a retracted position and an extended position.

12. The system of claim 1, wherein the auto-packing and/or sealing machine is disposed directly on the grid.

13. The system of claim 1, wherein the auto-packing and/or sealing machine is attached to the disposed indirectly on the grid.

14. The system of claim 13, wherein the auto-packing and/or sealing machine is attached to the one or more robots such that the auto-packing and/or sealing machine is disposed indirectly on the grid.

15. The system of claim 14, wherein the auto-packing and/or scaling machine is a compact auto-bagger.

16. The system of claim 1, wherein the one or more robots is configured to slot storage bins for storage, retrieve the storage bins, pick the inventory items, and pack the inventory items directly into the vessel for outbound shipment to an end user.
